(19) United States
(12) Patent Application Publication
(10) Pub. No.: US 2025/0321549 A1
(43) Pub. Date: Oct. 16, 2025

(54) SYSTEMS FOR AND METHODS OF PROVIDING USER INTERFACES FOR OBSERVATIONS AND RECOMMENDATIONS IN A BUILDING MANAGEMENT SYSTEM

(71) Applicant: Tyco Fire & Security GmbH, Neuhausen am Rheinfall (CH)

(72) Inventors: Benjamin Hidenori Shimazu, Scottsdale, AZ (US); Robbie Glen Davis, Kew Gardens, NY (US); Nicole Ann Madison, Milwaukee, WI (US); Kerry Marie Caravello, Mukwonago, WI (US); Mustapha Mufti, Dubai (AE); Michael James Risbeck, West Chester, OH (US); Shweta Kolwalkar, Lithia, FL (US); Surabhi Rajesh Shroff, King of Prussia, PA (US); Katianne Pechauer, Antioch, IL (US); Adrianna Pellitteri, Boca Raton, FL (US)

(21) Appl. No.: 19/176,929

(22) Filed: Apr. 11, 2025

Related U.S. Application Data
(60) Provisional application No. 63/633,494, filed on Apr. 12, 2024.

(51) Int. Cl. G05B 13/02

(52) U.S. Cl. CPC G05B 13/0265

(57) ABSTRACT

A system includes a plurality of equipment devices, and a controller including a memory storing instructions that, when executed by a processor, cause the processor to: obtain equipment operating data characterizing operation of a plurality of equipment devices, detect or predict a plurality of faults in the operation of the plurality of equipment devices based on the equipment operating data, analyze, using a machine learning model, the plurality of faults, rank, using the machine learning model, the plurality of faults according to one or more parameters of the equipment operating data, generate, using the machine learning model, one or more observations relating to the operation of the plurality of equipment devices and one or more recommendations to resolve the one or more faults, and generate, by the one or more processors, a user interface displaying the one or more observations and the one or more recommendations.

### CROSS-REFERENCE TO RELATED PATENT APPLICATIONS

This application claims priority to and the benefit of U.S. Provisional Patent Application No. 63/633,494, filed Apr. 12, 2024, the entirety of which is incorporated herein by reference in its entirety.

### BACKGROUND

The present disclosure relates generally to a building management system (BMS) and more particularly to a BMS with enterprise management and reporting. A BMS is, in general, a system of devices configured to control, monitor, and manage equipment in or around a building or building area. A BMS can include, for example, a HVAC system, a security system, a lighting system, a fire alerting system, life safety system, any other system that is capable of managing building functions or devices, or any combination thereof.

### SUMMARY

At least one embodiment relates to a system including equipment devices and a controller including one or more memories storing instructions thereon that, when executed by one or more processors, cause the one or more processors to: obtain equipment operating data characterizing operation of a plurality of equipment devices, detect or predict a plurality of faults in the operation of the plurality of equipment devices based on the equipment operating data, analyze, using a machine learning model, the plurality of faults, rank, using the machine learning model, the plurality of faults according to one or more parameters of the equipment operating data, generate, using the machine learning model, one or more observations relating to the operation of the plurality of equipment devices and one or more recommendations to resolve the one or more faults, and generate, by the one or more processors, a user interface displaying the one or more observations and the one or more recommendations.

In some embodiments, the one or more recommendations include one or more service events to service the plurality of equipment devices to resolve the one or more faults. In some embodiments, the instructions further cause the one or more processors to initiate an automated action to perform the one or more service events. In some embodiments, the plurality of equipment devices are distributed across a plurality of equipment sites including a building site and the plurality of equipment devices comprise HVAC equipment located at the building site.

In some embodiments, ranking the plurality of faults includes analyzing, by the machine learning model, the equipment operating data for each of the plurality of devices to identify one or more types of data of the equipment operating data, weighting, by the machine learning model, each of the one or more types of data based on a relevance of each of the one or more types of data to the one or more parameters of the equipment operating data, generating, by the machine learning model, a score indicative of the weighted one or more types of data, and prioritizing, by the machine learning model, the plurality of faults based on the generated scores.

In some embodiments, the one or more parameters of the equipment operating data comprise at least one of: an emissions impact of the device of equipment or a cost of the device of equipment.

In some embodiments, the instructions further cause the one or more processors to: identify a root cause of a first fault of the plurality of faults associated with a first device of the plurality of equipment devices, determine that the root cause of the first fault is a fault of a second device of the plurality of equipment devices, and generate, on a user interface displaying the one or more observations and the one or more recommendations of the first fault, an element indicating that the second device of the plurality of equipment devices is the root cause of the first fault.

Another aspect relates to a method including: obtaining, by one or more processors, equipment operating data characterizing operation of a plurality of equipment devices, detecting or predicting, by the one or more processors, a plurality of faults in the operation of the plurality of equipment devices based on the equipment operating data, analyzing, by the one or more processors, using a machine learning model, the plurality of faults, ranking, by the one or more processors, using the machine learning model, the plurality of faults according to one or more parameters of the equipment operating data, generating, by the one or more processors, using the machine learning model, one or more observations relating to the operation of the plurality of equipment devices and one or more recommendations to resolve the one or more faults, and generating, by the one or more processors, a user interface displaying the one or more observations and the one or more recommendations.

In some embodiments, the one or more recommendations include one or more service events to service the plurality of equipment devices to resolve the one or more faults. In some embodiments, the method includes initiating, by the one or more processors, an automated action to perform the one or more service events. In some embodiments, the plurality of equipment devices are distributed across a plurality of equipment sites including a building site and the plurality of equipment devices include HVAC equipment located at the building site.

In some embodiments, ranking the plurality of faults includes analyzing, by the one or more processors, using the machine learning model, the equipment operating data for each of the plurality of devices to identify one or more types of data of the equipment operating data, weighting, by the one or more processors, using the machine learning model, each of the one or more types of data based on a relevance of each of the one or more types of data to the one or more parameters of the equipment operating data, generating, by the one or more processors, using the machine learning model, a score indicative of the weighted one or more types of data, and prioritizing, by the one or more processors, using the machine learning model, the plurality of faults based on the generated scores.

In some embodiments, the one or more parameters of the equipment operating data include at least one of: an emissions impact of the device of equipment or a cost of the device of equipment. In some embodiments, the method further includes identifying, by the one or more processors, a root cause of a first fault of the plurality of faults associated with a first device of the plurality of equipment devices, determining, by the one or more processors, that the root cause of the first fault is a fault of a second device of the plurality of equipment devices, and generating, by the one or more processors, on a user interface displaying the one or more observations and the one or more recommendations of the first fault, an element indicating that the second device of the plurality of equipment devices is the root cause of the first fault.

Another aspect relates to one or more non-transitory computer-readable media including one or more memories storing instructions thereon that, when executed by one or more processors, cause the one or more processors to: obtain equipment operating data characterizing operation of a plurality of equipment devices, detect or predict a plurality of faults in the operation of the plurality of equipment devices based on the equipment operating data, analyze, using a machine learning model, the plurality of faults, rank, using the machine learning model, the plurality of faults according to one or more parameters of the equipment operating data, generate, using the machine learning model, one or more observations relating to the operation of the plurality of equipment devices and one or more recommendations to resolve the one or more faults, and generate a user interface displaying the one or more observations and the one or more recommendations. In some embodiments, the one or more recommendations include one or more service events to service the plurality of equipment devices to resolve the one or more faults. In some embodiments, the instructions further cause the one or more processors to: initiate an automated action to perform the one or more service events.

In some embodiments, ranking the plurality of faults includes analyzing, by the machine learning model, the equipment operating data for each of the plurality of devices to identify one or more types of data of the equipment operating data, weighting, by the machine learning model, each of the one or more types of data based on a relevance of each of the one or more types of data to the one or more parameters of the equipment operating data, generating, by the machine learning model, a score indicative of the weighted one or more types of data; and prioritizing, by the machine learning model, the plurality of faults based on the generated scores.

In some embodiments, the one or more parameters of the equipment operating data include at least one of: an emissions impact of the device of equipment or a cost of the device of equipment. In some embodiments, the instructions further cause the one or more processors to: identify a root cause of a first fault of the plurality of faults associated with a first device of the plurality of equipment devices, determine that the root cause of the first fault is a fault of a second device of the plurality of equipment devices, and generate, on a user interface displaying the one or more observations and the one or more recommendations of the first fault, an element indicating that the second device of the plurality of equipment devices is the root cause of the first fault.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a heating, ventilation, and/or air conditioning (HVAC) system, according to an exemplary embodiment.

FIG. 2 is a schematic diagram of a waterside system which can be used in conjunction with the building of FIG. 1, according to some embodiments.

FIG. 3 is a schematic diagram of an airside system which can be used in conjunction with the building of FIG. 1, according to some embodiments.

FIG. 4 is a block diagram of a building management system (BMS) which can be used to monitor and control the building of FIG. 1, according to some embodiments.

FIG. 5 is a block diagram of another BMS which can be used to monitor and control the building of FIG. 1, according to some embodiments.

FIG. 6 is a drawing of a user interface displaying a plurality of widgets, according to some embodiments.

FIG. 7A is a drawing of a user interface of an observations and recommendations widget displaying a plurality of widgets, according to some embodiments.

FIG. 7B is a drawing of a user interface of an observations and recommendations widget displaying a plurality of list items, according to some embodiments.

FIG. 7C is a drawing of a user interface for viewing active observations and recommendations in a widget view, according to some embodiments.

FIG. 7D is a drawing of a user interface for viewing active observations and recommendations in a list view, according to some embodiments.

FIG. 7E is a drawing of a user interface for viewing bookmarked observations and recommendations in a widget view, according to some embodiments.

FIG. 7F is a drawing of a user interface for viewing bookmarked observations and recommendations in a list view, according to some embodiments.

FIG. 8 is a drawing of a user interface for viewing a summary of an observation and recommendation, according to some embodiments.

FIG. 9 is a drawing of a user interface for viewing supporting data of an observation and a recommendation, according to some embodiments.

FIG. 10 is a diagram of a user interface for viewing implementation steps, according to some embodiments.

FIG. 11 is a diagram of a user interface for assigning and scheduling implementation of a recommendation, according to some embodiments.

FIG. 12A is a drawing of a first user interface for declining an implementation of a recommendation, according to some embodiments.

FIG. 12B is a drawing of a second user interface for declining an implementation of a recommendation, according to some embodiments.

FIG. 13A is a drawing of a first user interface for reversing an implementation of a recommendation, according to some embodiments.

FIG. 13B is a drawing of a second user interface for reversing an implementation of a recommendation, according to some embodiments.

FIG. 14A is a drawing of a first user interface for sharing an observation and recommendation, according to some embodiments.

FIG. 14B is a drawing of a second user interface for sharing an observation and recommendation, according to some embodiments.

FIG. 15 is a drawing of a user interface for adding a recommendation to a to-do list, according to some embodiments.

FIG. 16 is a drawing of a user interface of an active observation and recommendation, according to some embodiments.

FIG. 17 is a drawing of an artificial intelligence chatbot, according to some embodiments.

FIG. 18A is a drawing of user interface displaying a plurality of widgets, according to some embodiments.

FIG. 18B is a drawing of a user interface displaying observations and recommendations, according to some embodiments.

FIG. 18C is a drawing of a user interface for viewing a summary of an observation and recommendation, according to some embodiments.

FIG. 18D is a drawing of a user interface for creating a work order, according to some embodiments.

FIG. 18E is a drawing of a user interface for viewing a summary of an observation and recommendation, according to some embodiments.

FIG. 19A is a drawing of a user interface for viewing an asset manager, according to some embodiments.

FIG. 19B is a drawing of a user interface for viewing health of various pieces of building equipment, according to some embodiments.

FIG. 20A is a drawing of a flowchart showing a method of generating observations and recommendations, according to some embodiments.

FIG. 20B is a drawing of a graph and equations of a five parameter regression model, according to some embodiments.

FIG. 20C is a chart illustrating logic for generating recommendations, according to some embodiments.

FIG. 21 is a drawing of a block diagram of a predictive model, according to some embodiments.

FIG. 22 is a drawing of a block diagram of a generative artificial intelligence model, according to some embodiments.

FIG. 23 is a flow diagram of a method for ranking equipment faults, according to some embodiments.

### DETAILED DESCRIPTION

Referring generally to the FIGURES, systems and methods are provided for an integrated global chiller maintenance scheduling system with virtual inspection report optimization.

Pieces of building equipment or equipment devices can experience faults that require maintenance or servicing by a technician to resolve. It can be difficult to determine whether a service technician should be dispatched to a location of the equipment or remotely service the equipment.

Technically and beneficially, the systems and methods of some embodiments described herein provide an automated manner of detecting faults and automatically generating observations regarding the fault, such as causes of the fault and operating parameters of the equipment while experiencing the fault, as well as recommendations regarding how to service the equipment to resolve the fault. Generating observations and recommendations and providing them to a user via a user interface allows a user to view the information in a more concise manner in some embodiments. This can lead to reduced workflow, thereby causing equipment to be serviced more quickly. This improves equipment performance and can reduce equipment downtimes that may cause inefficiencies and increased emissions. Further, the systems and methods described herein utilize a plurality of LLMs to quickly synthesize data. The LLMs may rank faults according to one or more predetermined parameters. Further, the LLMs may parse through a large number of faults and may rank or prioritize only a subset of these faults. This may reduce processing power that would be associated with analyzing all faults and ranking them. Further, by only identifying a subset of faults that are ranked highly, indicating an importance of addressing those faults, equipment and overall building performance is optimized.

Further, the systems and methods described herein provide for faster servicing of high importance or critical faults. For example, automatically ranking faults using information including a criticality or severity of the fault can cause a service provider to be dispatched to that fault more quickly. Advantageously, the system described herein optimally allocates service provider resources and makes use of remote diagnostics, automatic repairs, and remote fixes when possible to ensure that faults in equipment devices are repaired quickly and efficiently while minimizing or reducing the need for human intervention. This reduces the amount of time that the equipment devices operate in a fault state or are rendered inoperable by unrepaired faults. The repaired equipment devices may operate more efficiently and reliably, which leads to less energy consumption, reduced carbon emissions, less downtime, and other technical improvements. These and other improvements and advantages are described in detail throughout the present disclosure.

### Building HVAC Systems and Building Management Systems

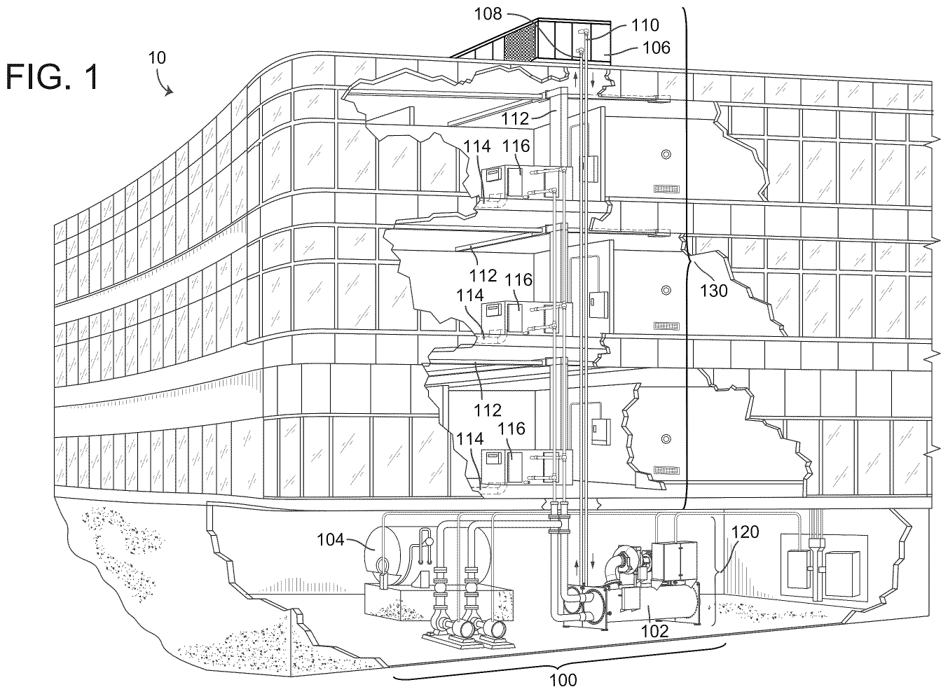

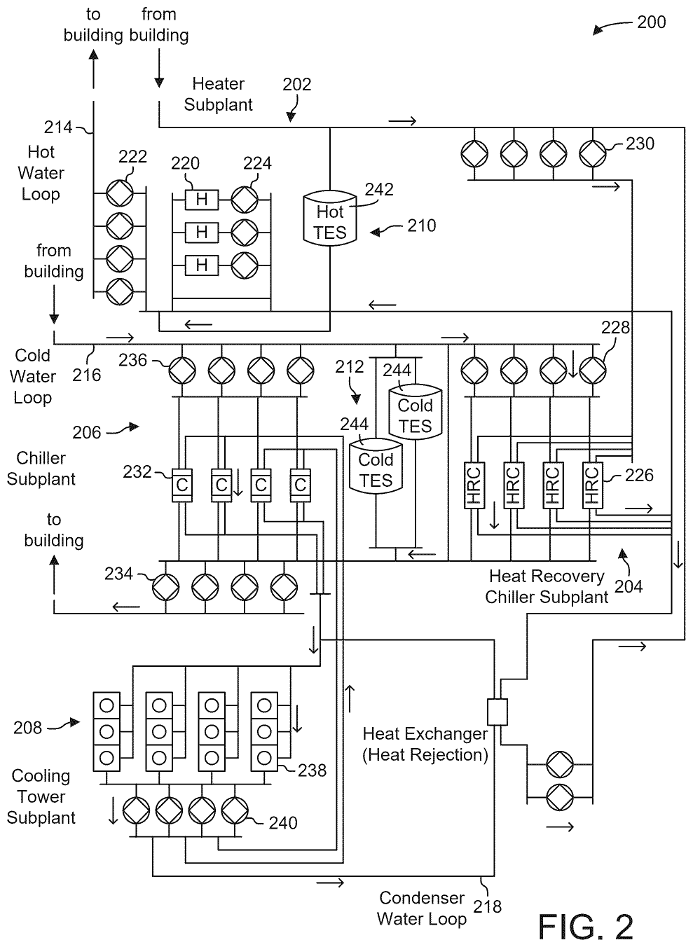

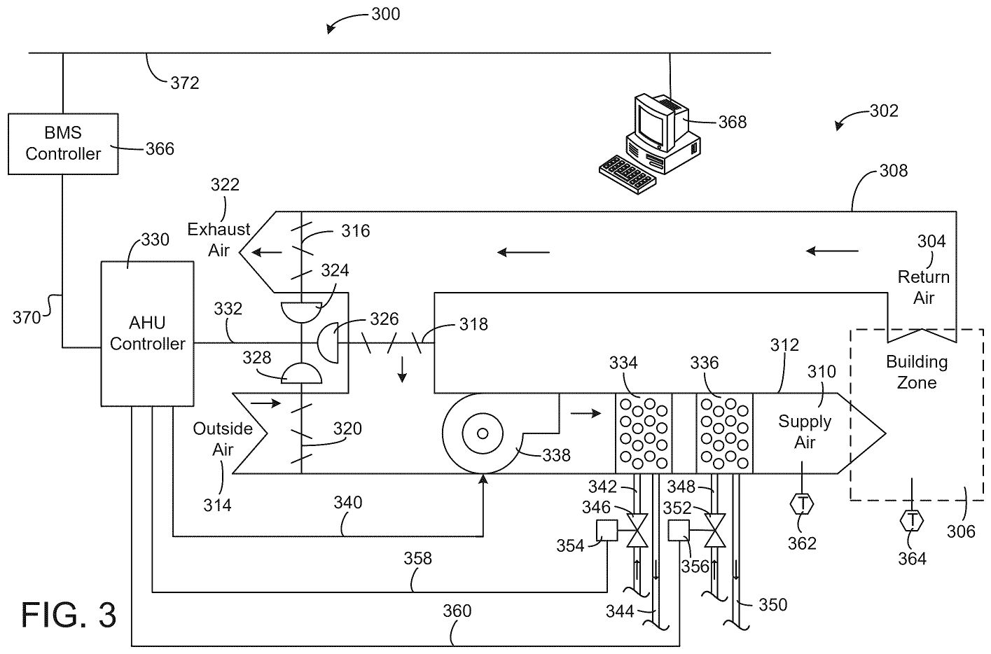

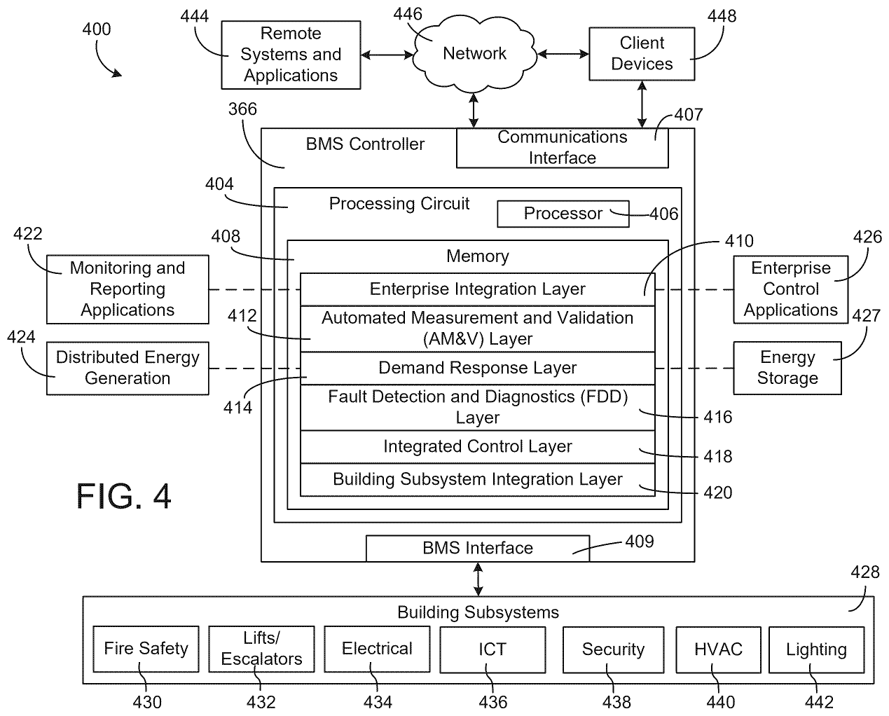

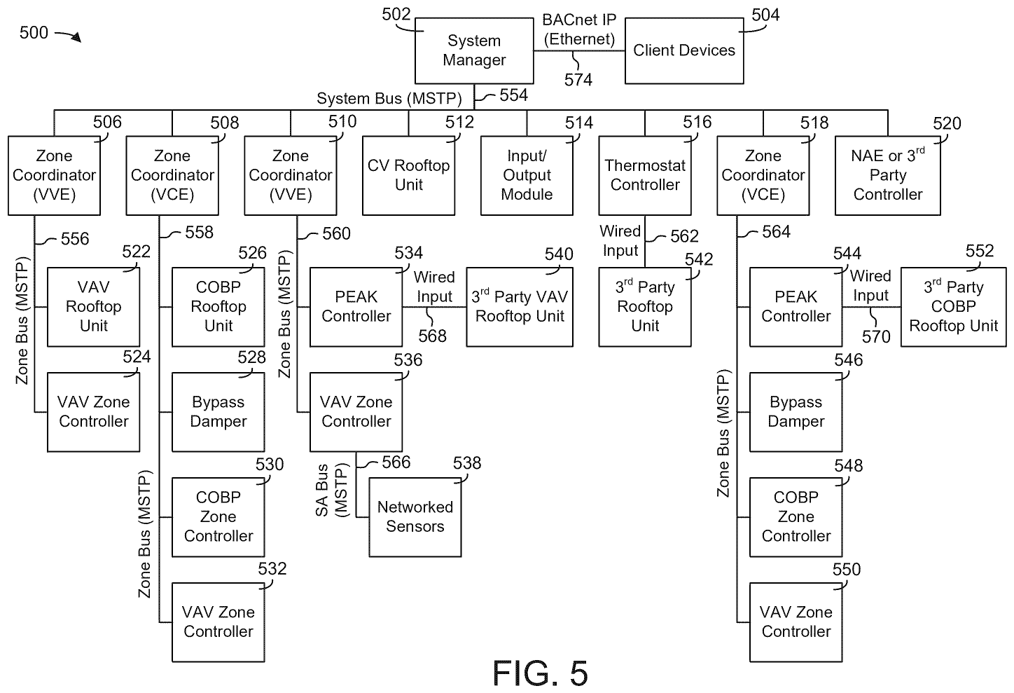

Referring now to FIGS. 1-5, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10. FIG. 5 is a block diagram of another BMS which can be used to monitor and control building 10.

### Building 10 and HVAC System 100

Referring particularly to FIG. 1, a perspective view of building 10 is shown. Building 10 is served by a BMS. A BMS is, in general, a system of equipment devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2 and 3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System 200

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System 300

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management System 400

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2 and 3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, thermostats, and other devices for controlling the temperature, humidity, airflow, or other variable conditions within building 10. Lighting subsystem 442 can include any number of light fixtures, ballasts, lighting sensors, dimmers, and/or other devices configured to controllably adjust the amount of light provided to a building space. Security subsystem 438 can include occupancy sensors, video surveillance cameras, digital video recorders, video processing servers, intrusion detection devices, access control devices and servers, and/or other security-related devices.

Still referring to FIG. 4, BMS controller 366 is shown to include a communications interface 407 and a BMS interface 409. Communications interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Communications interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Communications interfaces 407 and/or BMS interface 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via communications interfaces 407 and/or BMS interface 409 can be direct (e.g., local wired or wireless communications) or via a communications network 446 (e.g., a WAN, the Internet, a cellular network, etc.). For example, communications interfaces 407 and/or BMS interface 409 can include an Ethernet card and port for sending and receiving data via an Ethernet-based communications link or network. In another example, communications interfaces 407 and/or BMS interface 409 can include a Wi-Fi transceiver for communicating via a wireless communications network. In another example, one or both of communications interfaces 407 and BMS interface 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via communications interfaces 407 and/or BMS interface 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at communications interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs (e.g., internal to building 10, external to building 10, etc.) such as temperature, carbon dioxide levels, relative humidity levels, air quality sensor outputs, occupancy sensor outputs, room schedules, weather conditions, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints, etc.) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface, etc.) so that the control actions initiated in response to demand inputs can be tailored for the user's application, desired comfort level, particular building equipment, and/or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and/or when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, and/or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage, etc.) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

Several examples of FDD models and processes that can be used by the system 400 are described in detail in U.S. Pat. No. 10,969,775 granted Apr. 6, 2021, U.S. Pat. No. 10,700,942 granted Jun. 30, 2020, U.S. Pat. No. 9,568,910 granted Feb. 14, 2017, U.S. Pat. No. 10,281,363 granted May 7, 2019, U.S. Pat. No. 10,747,187 granted Aug. 18, 2020, U.S. Pat. No. 9,753,455 granted Sep. 5, 2017, and U.S. Pat. No. 8,731,724 granted May 20, 2014. The entire disclosures of each of these patents are incorporated by reference herein. The system 400 can use these or other FDD models or processes to help diagnose the root causes of problems associated with the building equipment and identify the particular actions that can be taken by the system 400 or by service providers (e.g., performing service on building equipment, repairing or replacing building equipment, switching to a new control strategy, automatically updating device software or firmware, etc.) to improve the performance of the building equipment and resolve the problems associated with the service requests and/or service reports for the building equipment.

In some embodiments, the system 400 may have associated warranty data. In some embodiments, the warranty data include reliability data that indicate the failure rates, expected time until failure, or other reliability metrics of various types of building equipment (e.g., particular equipment models) or components thereof. The reliability data can be generated from a set of service actions performed by a manufacturer or service provider and/or warranty claims submitted by various customers across a large set of building equipment over time. In some embodiments, the warranty data include freeform text included in warranty claims, photographs or videos of failed equipment, service reports generated when performing service on equipment under warranty, or any other type of data associated with equipment under warranty. These and other examples of warranty data are described in greater detail in U.S. patent application Ser. No. 17/971,342 filed Oct. 21, 2022, U.S. patent application Ser. No. 18/116,974 filed Mar. 3, 2023, U.S. patent application Ser. No. 17/530,257 filed Nov. 18, 2021, and Singapore patent application Ser. No. 10/202,250321D filed Jun. 28, 2022, the entire disclosures of which are incorporated by reference herein. The warranty data can include structured and/or unstructured data of any type or format.

### Building Management System 500

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment.

BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models. An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a system manager 502; several zone coordinators 506, 508, 510 and 518; and several zone controllers 524, 530, 532, 536, 548, and 550. System manager 502 can monitor data points in BMS 500 and report monitored variables to various monitoring and/or control applications. System manager 502 can communicate with client devices 504 (e.g., user devices, desktop computers, laptop computers, mobile devices, etc.) via a data communications link 574 (e.g., BACnet IP, Ethernet, wired or wireless communications, etc.). System manager 502 can provide a user interface to client devices 504 via data communications link 574. The user interface may allow users to monitor and/or control BMS 500 via client devices 504.

In some embodiments, system manager 502 is connected with zone coordinators 506-510 and 518 via a system bus 554. System manager 502 can be configured to communicate with zone coordinators 506-510 and 518 via system bus 554 using a master-slave token passing (MSTP) protocol or any other communications protocol. System bus 554 can also connect system manager 502 with other devices such as a constant volume (CV) rooftop unit (RTU) 512, an input/output module (IOM) 514, a thermostat controller 516 (e.g., a TEC5000 series thermostat controller), and a network automation engine (NAE) or third-party controller 520. RTU 512 can be configured to communicate directly with system manager 502 and can be connected directly to system bus 554. Other RTUs can communicate with system manager 502 via an intermediate device. For example, a wired input 562 can connect a third-party RTU 542 to thermostat controller 516, which connects to system bus 554.

System manager 502 can provide a user interface for any device containing an equipment model. Devices such as zone coordinators 506-510 and 518 and thermostat controller 516 can provide their equipment models to system manager 502 via system bus 554. In some embodiments, system manager 502 automatically creates equipment models for connected devices that do not contain an equipment model (e.g., IOM 514, third party controller 520, etc.). For example, system manager 502 can create an equipment model for any device that responds to a device tree request. The equipment models created by system manager 502 can be stored within system manager 502. System manager 502 can then provide a user interface for devices that do not contain their own equipment models using the equipment models created by system manager 502. In some embodiments, system manager 502 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

### Observations and Recommendations User Interface

In various embodiments, observations may be generated for one or more components of a building management system such as the systems described above with reference to FIGS. 1-5. Components may include, for example, pieces of equipment (e.g., chillers, HVAC units, heating systems, etc.), individual buildings, and/or zones of a building (e.g., a floor, an office, etc.) including but not limited to any of the components described above with reference to FIGS. 1-5. Observations may be related to performance of the component. Specifically, observations may be generated for components that are not running on optimal conditions. For example, observations may be made relating to parameters such as energy consumption, usage (e.g., electricity usage, natural gas usage, etc.), energy usage intensity (EUI), cost, emissions information, etc. An observation may be generated using artificial intelligence. For example, for a piece of building equipment, an AI system may use, as inputs, historical data for the component, data for similar components (e.g., usage data for a different one of the same type of component), or any data relating to one or more of the parameters listed above. The AI system may generate, from the data, one or more observations for the component performance. The AI system may generate a textual description or summary of the observations. For example, the AI system may generate a brief one line title or summary of the observations. The AI system may also generate detailed descriptions of the observations for the component. For example, an observation may be that heating consumption for a building is high. Observations may also be related to building performance compared to regulatory standards. For example, an observation may be that a building is operating such that it is outside of regulatory emissions limit compliance. The AI system may assign each observation an urgency score or indicator that indicates urgency or importance of resolving the observation. The AI system may be part of system manager 502 or be provided using a remote server in some embodiments.

The AI system may generate one or more recommendations corresponding to the observations made. The recommendations may be actions to take so that the component is operating optimally or for efficiently. The AI system may generate the recommendations using historical data to determine actions that are known to resolve the observations. For example, if a building is consuming high amounts of electricity, the AI system may use historical data relating to another building that previously consumed high amounts of energy. The AI system may determine actions taken at the other building to resolve its energy usage, and may provide, as a recommendation, the same actions to the building currently consuming high amounts of energy. Generation of recommendations is described in greater detail in U.S. Provisional Patent No. 63/466,203 filed May 12, 2023, and U.S. patent Ser. No. 17/354,583 filed Jun. 22, 2021, each of which is incorporated by reference in its entirety herein.

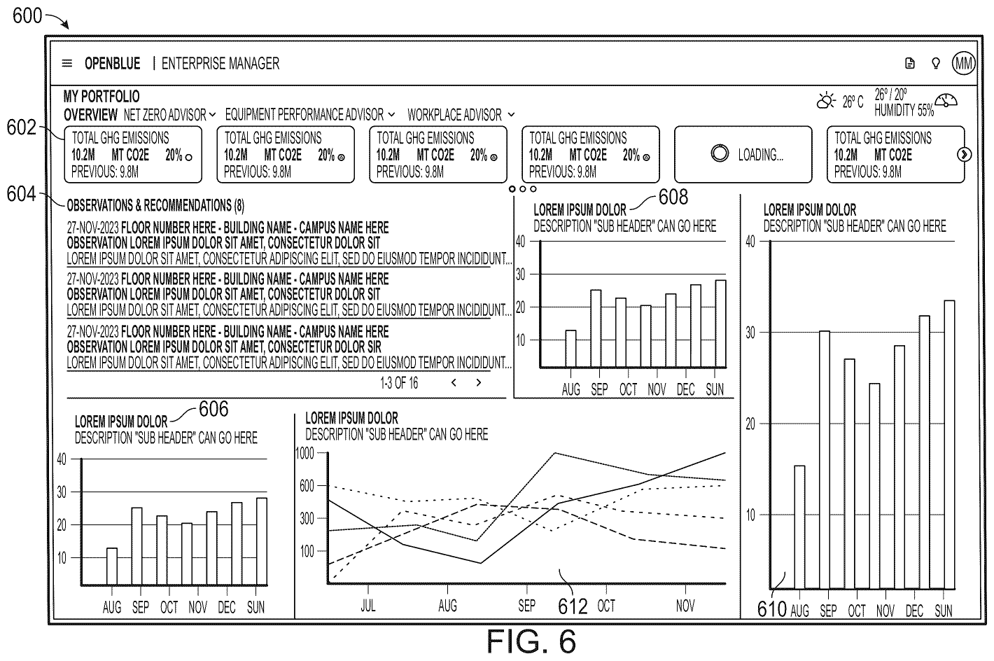

Referring generally to FIGS. 6-17, a plurality of user interfaces are shown and described. The user interfaces may be various interfaces of a single or multiple program or application. Each user interface may be a separate window or may be various portions of a single window or screen. The user interfaces described herein may be related to the observations and recommendations generated by the AI system described above. For example, the generated observations and recommendations and related information may be displayed on one or more of the user interfaces described with respect to FIGS. 6-17.

Referring now to FIG. 6, a user interface (UI) 600 for a dashboard is shown, according to an example embodiment. The dashboard is for a building manage system in some embodiments. The dashboard may display information on a number of widgets (e.g., widgets 602, 604, 606, 608, 610, and 612). Each widget may be selectable. For example, each widget can be selected to display a separate window showing the information on the widget and/or additional information. The information may be relating to one or more building components of a BMS. For example, the UI 600 may display health information relating to one or more chillers of a BMS. The UI 600 may be customizable or configurable by a user. For example, the user may edit which widgets are shown on the UI 600 and/or what information is displayed on each widget. Further, the user may move the widgets around the UI 600 to configure different layouts of the UI.

The UI 600 may include a number of widgets displaying various information relating to one or more components. A number of widgets 602 may display emissions information for the number of building components. For example, the emissions widget 602 may indicate a total emissions of a piece of building equipment for a specified time period (e.g., the previous 12 months). A user may be able to scroll through the number of emissions widgets 602 to view emissions information about multiple pieces of equipment. The widget may also include an indication of a change in emissions for the equipment. For example, the widget may indicate that the equipment has decreased carbon emissions by 20% since the same time one year ago. In various embodiments, the widgets 602 may be configurable to display information other than emissions information, such as a run time of one or more pieces of equipment.

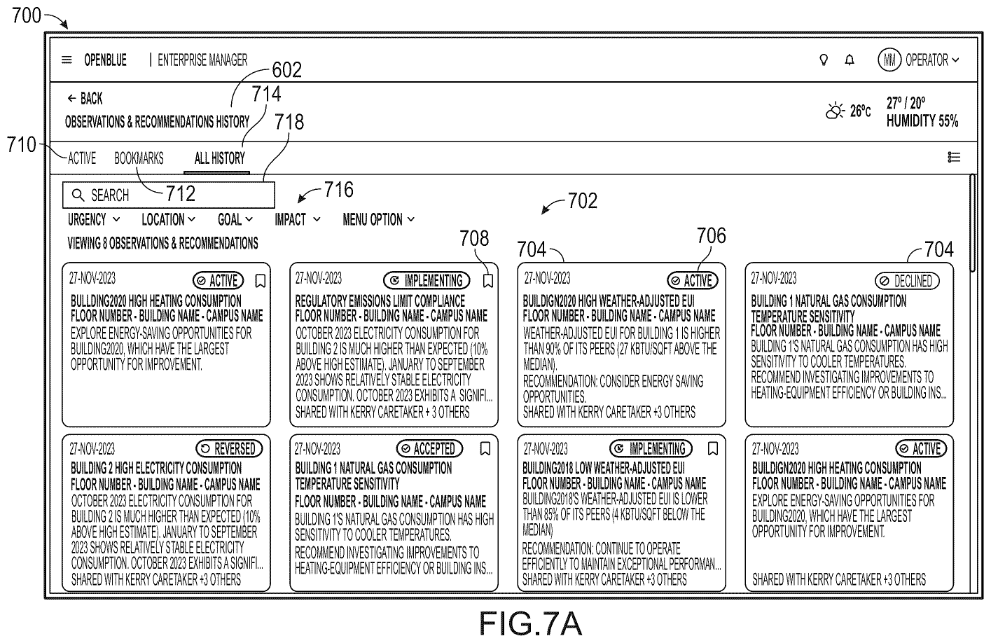

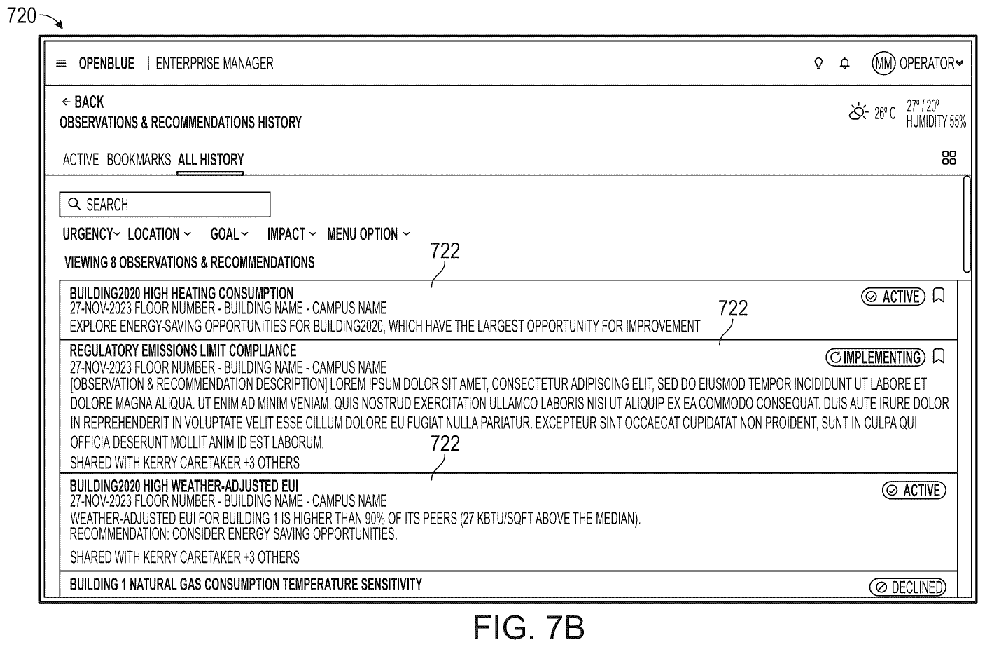

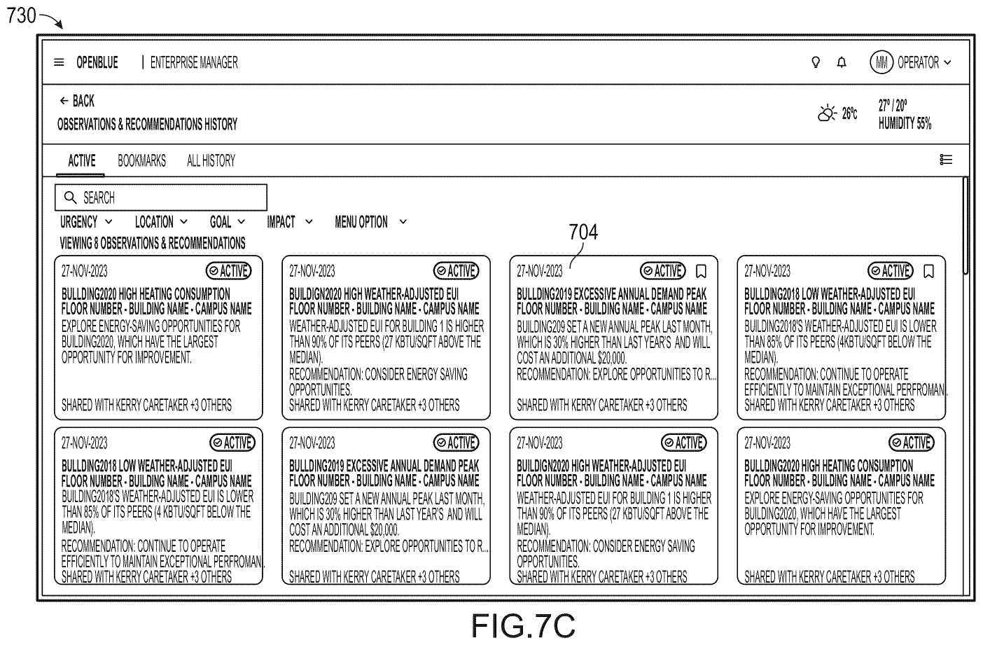

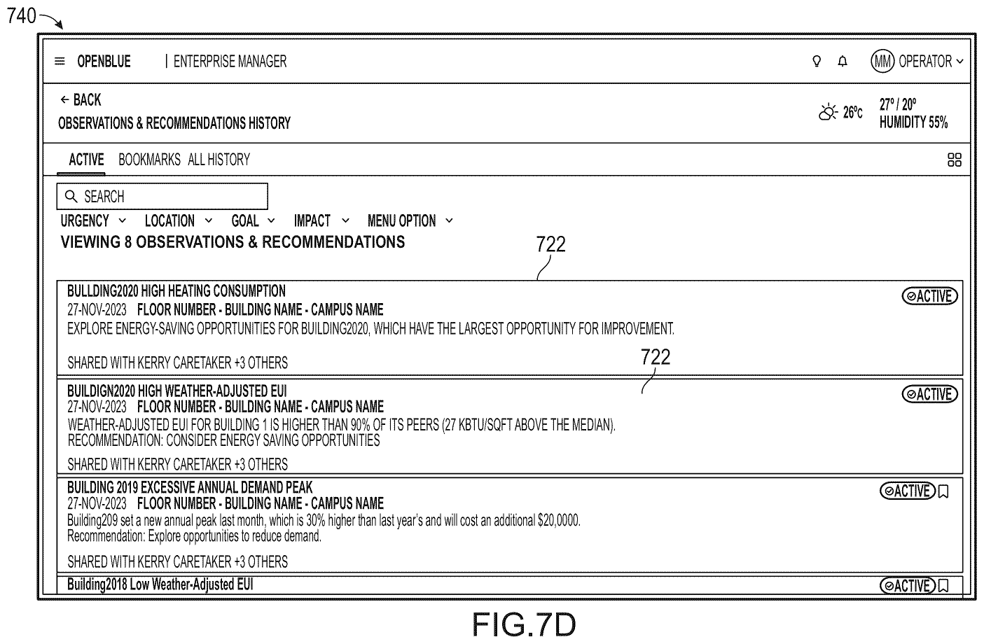

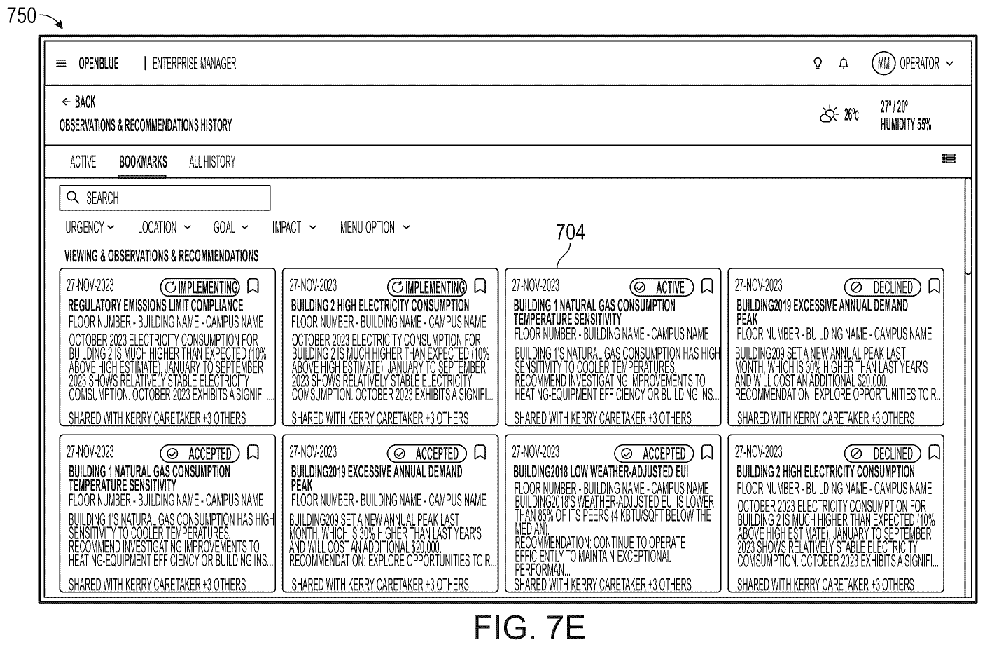

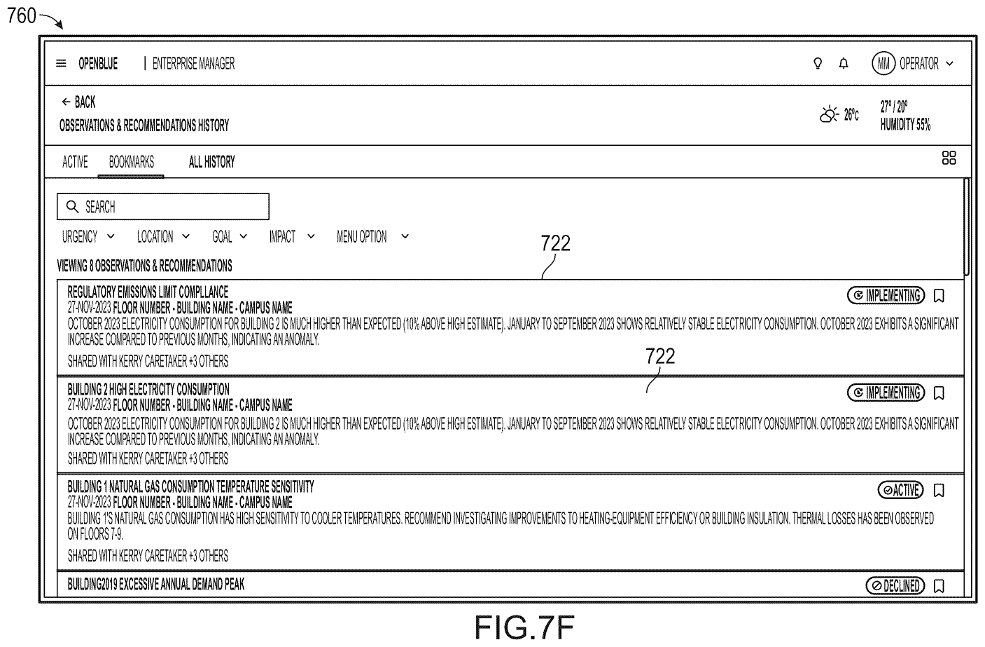

The UI 600 may include an observations and recommendations widget 604. The observations and recommendations widget 604 may include one or more observations and recommendations relating to the performance of the equipment. The observations and recommendations may be determined by an AI system, as described above. A title of the widget may identify the widget as showing observations and recommendations. The title may also include a number of observations. For example, in FIG. 6, the title of widget 602 is “Observations & Recommendations (8),” indicating that 8 separate observations have been generated and are available to view. For example, the observations and recommendations widget 604 may display a fault of a piece of building equipment or an observation of how the equipment is running or performing. For each observation, the name and location of the piece of equipment may be displayed. The date of the observation and/or fault may also be displayed. A brief title or summary of the observation may be displayed. A portion of a more detailed description of the observation may be displayed. The complete detailed description may be viewed by selecting the observation on the widget 604. Selecting the observation may cause a pop up or window to appear showing additional information. In various embodiments, selecting the observations and recommendations title may display the one or more observations and recommendations. The widget 604 will be described in greater detail with respect to FIGS. 7-17.

In various embodiments, the information displayed on the observations and recommendations widget 602 may be AI-generated. One or more components of the BMS (e.g., BMS 500) may generate the user interface(s) described with respect to FIGS. 6-17. For example, system manager 502 of the BMS 500 can provide a user interface (e.g., UI 600) to one or more devices (e.g., client devices 504). The device(s) displaying the user interfaces may be, for example, computers, user input devices, mobile devices, etc. The system manager 502 may provide the user interface to the one or more client devices via data communications link 574. The user interface may allow users to monitor and/or control BMS 500 via client devices 504.

The UI 600 may further include additional widgets, such as widgets 606, 608, 610, and 612. As shown in FIG. 6, widgets 606-612 are shown as displaying graphical information. For example, widgets 606, 608, and 610 are bar charts, while widget 612 is a line graph. Each widget may display graphical information relating to performance of one or more pieces of building equipment. For example, widget 606 may display a monthly usage for one piece of equipment, while widget 608 displays monthly usage for a second piece of equipment. As an example, widget 612 may be a line graph comparing monthly performance of a number of pieces of building equipment. In various embodiments, widgets 606-612 may display information in a form other than a graph. In various embodiments, the UI 600 may include a lesser or greater number of widgets than shown in FIG. 6.

Referring now to FIG. 7A, a UI 700 is shown. The UI 700 is a UI of the observations and recommendations widget 602 of FIG. 6. For example, the UI 700 is an example UI appearing responsive to a user selecting the observations and recommendations widget 602 on the UI 600 of FIG. 6. Specifically, the user may select, on the observations and recommendations widget 602 of the UI 600, a “view history” option to view the UI 700. The UI 700 may be customizable and configurable by a user such that a variety of information is shown according to user preferences.

The UI 700 includes a section 702 of the interface for viewing the number of observations and recommendations indicated by the observations and recommendations title 604 of FIG. 6. The section 702 may include one or more observation widgets 704. The number of widgets 704 may correspond to a number of observations made about one or more pieces of equipment. For example, if eight observations have been made about one or more pieces of equipment, eight widgets 704 will be shown in the section 702. The widgets 704 may be displayed in rows and columns. In various embodiments, the section 702 may be configured such that each widget 704 is displayed as a list item instead of a widget. Each widget 704 may include a number of pieces of information relating to the observation of the piece of equipment. The information may be the same or similar to the information shown for each observation on the observations and recommendations widget 602. For example, each widget 704 may include the name and location of the piece of equipment and the date of the observation and/or fault. A brief title or summary of the observation may be displayed. A portion of a more detailed description of the observation may be displayed.

In various embodiments, and as will be described in greater detail, each observation may be shared with one or more people. For example, a user at a company may share the recommendation with others at the company so they have the ability to view the observation. Each widget 704 may indicate who the observation is shared with.

In various embodiments, each widget 704 may include a status indicator 706. The status indicator may indicate the status of an implementation of the recommendation for the observation. For example, a first widget 704 may include an observation that a building is exceeding an energy limit. The corresponding recommendation may be to reduce power in the building by turning off lights in unoccupied areas. The status indicator 706 may indicate a status of implementing the recommendation to turn off lights in the unoccupied areas. Statuses may be, for example, an “accepted” status, an “implementing” status, an “active” status, a “declined” status, and/or a “reversed” status. The “accepted” status may indicate that the user has accepted the recommendation, but the recommended actions have not yet been implemented. The “implementing” status may indicate that the recommendation has been accepted and the recommended actions are currently being implemented. The steps may be implemented, for example, digitally using artificial intelligence and/or manually by a service technician. The “active” status may indicate that the recommendation has been implemented fully and the equipment is operating in accordance with the recommended actions. The “declined” status may indicate that the recommendation has been declined by the user and the recommended actions have not and will not be implemented in the equipment. The “reversed” status may indicate that the user has previously accepted to or has implemented the recommendation but has reversed the decision, and the equipment is no longer implementing the recommendation.

In various embodiments, the information displayed on the widget 704 may change depending on the status of the implementation of the recommendation. For example, a widget with an “active” status may show how the implementation of the recommendation has affected operation of the component and/or additional recommendations to further improve performance of the component.

Each widget 704 may also include a bookmark 708. The user may select to bookmark the widget 708 to easily view the information on the widget. The user may be able to bookmark the widget by selecting the bookmark icon 708. The UI 700 also includes a number of tabs, shown as tabs 720, 712, and 714. Under each tab of the number of tabs, different widgets are saved and can be viewed according to different identifiers of the widgets 704. For example, under the Active tab 710, all widgets 704 that have an “active” status indicator 706 are displayed. Under the Bookmarks tab 712, all widgets 704 that have been bookmarked by the user are displayed. Under the All History tab 714, all widgets 704 corresponding to all observations and corresponding recommendations that have been generated are displayed. In various embodiments, responsive to clicking on the “Observations and Recommendations” title or a “view history” tab on the observations and recommendations widget 602 of UI 600, the user may be brought to the All History tab 714 to view all widgets 704. In various embodiments, the UI 700 may be customizable such that the user can select a default tab that displays upon selecting the “Observations and Recommendations” title of the observations and recommendations widget 602. In various embodiments, the UI 700 may remember the last tab a user viewed and open to that tab the next time the user views the UI 700. In various embodiments, the number of tabs may include different or additional tabs. For example, the user may configure the UI 700 to include an “Implementing” tab to view all recommendations that are currently being implemented.

In various embodiments, a number of filters 716 may be available to filter which widgets 704 are viewed by the user. The user may select to filter by, for example, urgency that the observation is addressed, location of the component, goal (e.g., emissions goal, consumption goal, usage goal, etc.), amount of impact the implementation will have, type of impact, etc. For each filter, the user may be able to sort the widgets. For example, the user can determine whether the widgets are sorted such that urgency of the observations is in an ascending or descending order. The user may be able to select which filters are displayed on the UI 700. Additionally, the UI 700 may include a search bar 718. The user may be able to search for a specific widget 704 by inputting keywords or tags related to the observations and/or recommendations of a widget 704. The search results may be able to be filtered using the filters 716.

Referring now to FIGS. 7B-7F, a number of views of the UI 700 are shown. For example, FIG. 7B shows a UI 720 displaying the All History tab 714 in a list view. For example, widgets 704 of FIG. 7A are shown as list items 722. The user may scroll down the UI 720 to view the list items 704. FIG. 7C shows a UI 730 displaying the Active tab 710. Widgets 704 are observations and recommendations that have an active status. FIG. 7D is a UI 740 displaying the Active tab 710 in a list view. The observations and recommendations that have an active status are displayed as list items 722. FIG. 7E is a UI 750 displaying the Bookmarks tab 712. Widgets 704 are observations and recommendations that have been bookmarked by the user. FIG. 7F is a UI 760 displaying the Bookmarks tab 712 in a list view. The observations and recommendations that have been bookmarked by the user are displayed as list items 722.

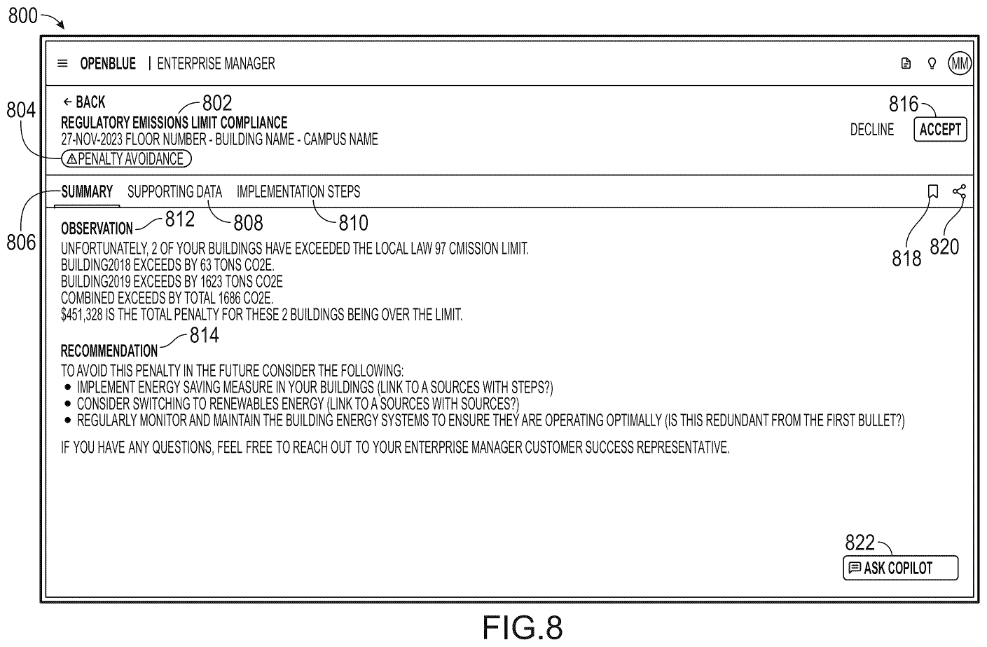

Referring now to FIG. 8, a UI 800 is shown, according to an example embodiment. The UI 800 is a first UI seen by a user responsive to selecting a specific observation and recommendation from the observation and recommendation widget 602 of UI 600 or a specific widget 704 from the UI 700.

The UI 800 may include a title 802. The title may be the same as the title shown in the widget 704 that indicates a brief summary of the observations made for the component. The UI 800 may include a notification 804. The notification 804 may categorize the observation according to the type of observation and recommendation. For example, as shown in FIG. 8, the notification 804 indicates that implementing the recommendation will result in a penalty avoidance (e.g., implementing the recommendations will allow the building to be compliant with regulations where noncompliance would result in a penalty). The UI 800 further includes a number of tabs, shown as tabs 806, 808, and 810. The summary tab 806 provides a summary view of the observations and recommendations for the component.

When the summary tab 806 is selected, observations 812 and recommendations 814 are displayed. Observations 812 include detailed information about the operation of the component. The text displayed as observations 812 may include the portion of text displayed for each observation and recommendation on one or more of the observation and recommendation widget 602 and the widget 704. Observations 812 may include AI-generated text describing information relating to performance or efficiency of the component. For example, the observation may indicate that buildings have exceeded regulatory emissions limits. The observations 812 may describe details relating to the performance, such as by how much the component has exceeded the limit and a cost associated with exceeding the emissions limit.

Recommendations 814 may also be shown when the summary tab 806 is selected. The recommendations 814 may include one or more steps, items, actions, etc. to take to address the observations 812. In various embodiments, the recommendations 814 may include items that can address a current penalty or problem. In various embodiments, the recommendations 814 may include items that can prevent a penalty or problem from occurring in the future. The recommendations 814 may include links to sources or additional information relating to the listed recommendation.

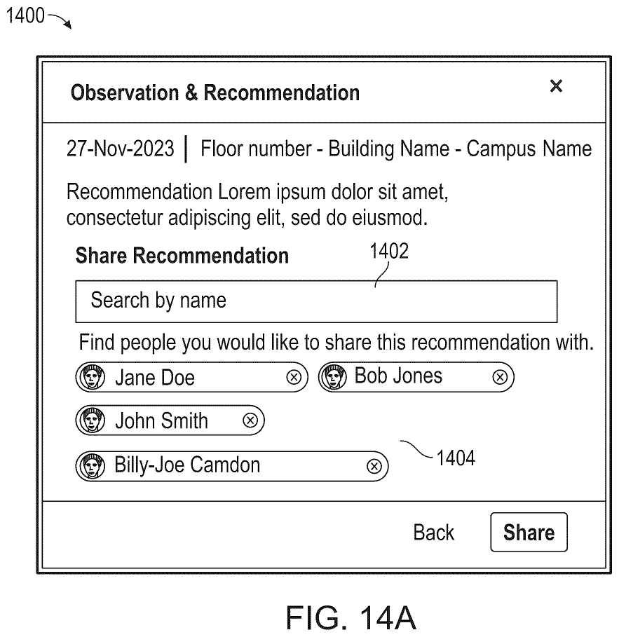

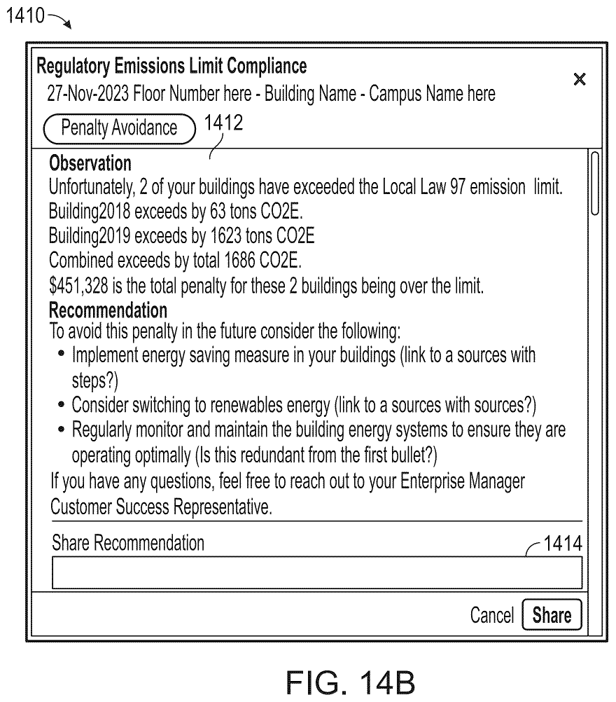

The UI 800 further includes an option 816 to accept or decline the recommendation 814. The user can select the accept option if the recommendations should be implemented. The user can select the decline option if the recommendation should not be implemented. The UI 800 further includes a bookmark button 818. As described above with reference to bookmark 708 of FIG. 7, the bookmark button 818 can bookmark the observation and recommendation. The bookmarked observation and recommendation may then display as a widget 704 in the Bookmarks tab 712 of the UI 700. The UI 800 may also include a share button 820. The share feature is described in greater detail with reference to FIGS. 14A and 14B. Selecting the share button 820 may allow a user to share the observation and recommendation with one or more additional users.

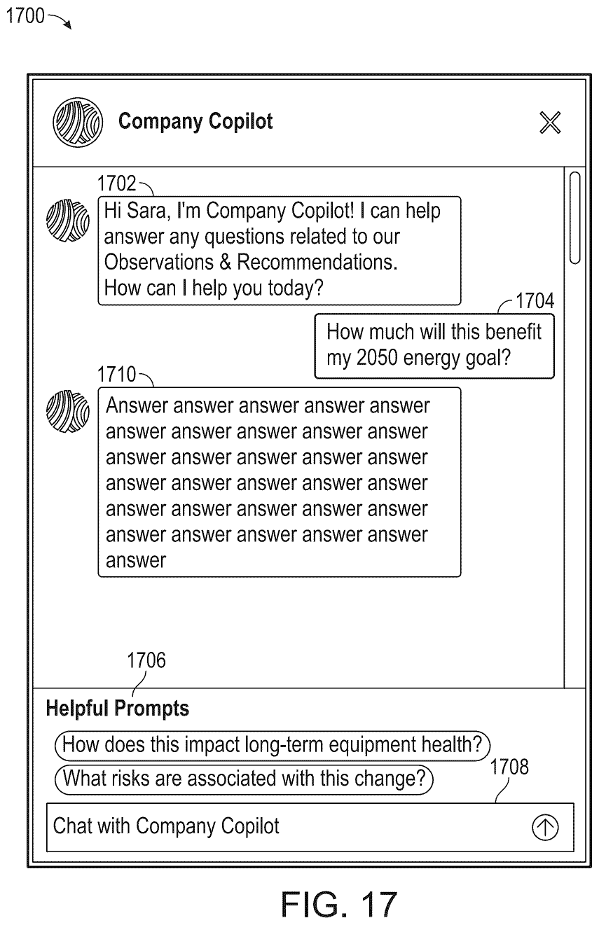

The UI 800 further includes a chatbot icon 822. The chatbot icon can be selected to display a conversational chatbot. The chatbot may be powered using an AI system. A user may ask a question or input a prompt to the chatbot, and the chatbot may display a response to the question or prompt. The chatbot feature is described in greater detail with respect to FIG. 17.

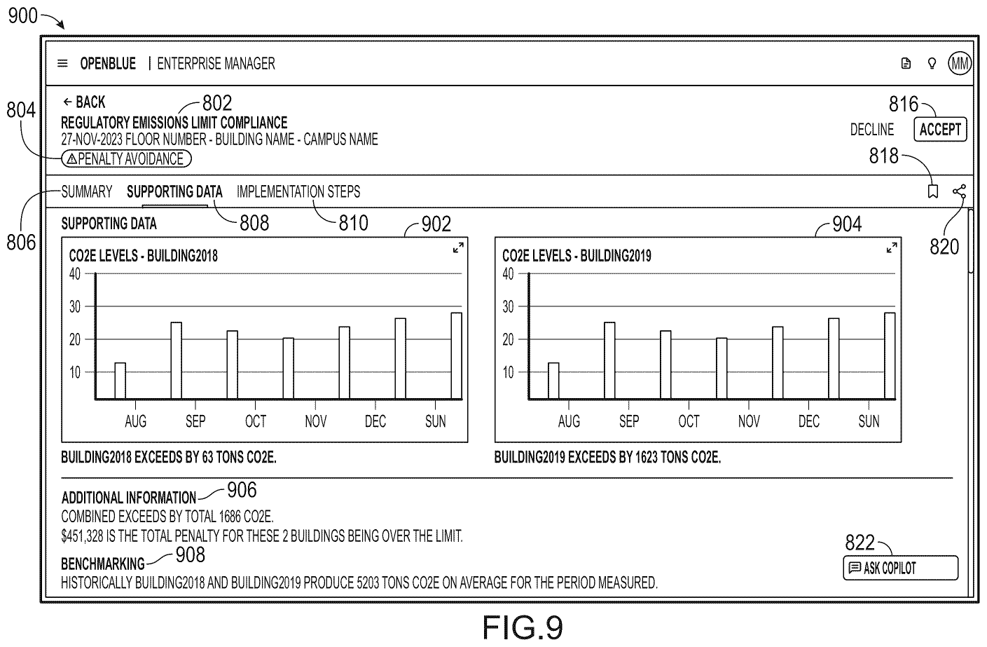

Referring now to FIG. 9, a UI 900 is shown, according to an example embodiment. The UI 900 is an expanded view of the same observation and recommendation of FIG. 8 with the Supporting Data tab 808 selected. As such, elements 802-810 and 816-822 are the same elements 802-810 and 816-822 described with respect to FIG. 8.

Referring still to FIG. 9, the Supporting Data tab 808 is selected. The Supporting Data tab allows information about the operation of the component to be displayed. For example, graphs 902 and 904 are shown. Graphs 902 and 904 each display monthly carbon emissions for a respective building that are the subject of the observation and recommendation. In various embodiments, the graphs 902 and 904 may be different types of graphs, such as line graphs. In various embodiments, the graphs 902 and 904 may be non-graphical visual representations of component data. In various embodiments, the one or more of the graphs 902 and 904 may be replaced with textual supporting information, such as charts or tables.

The Supporting Data tab 808 also includes additional information 906. Additional information 906 may be or include information about the components not found in the graphs 902 and 904 or the observations 812 in the Summary tab 806. The information may be relevant to the observations 812. For example, the additional information may include a list of previous upgrades to the component. In various embodiments, the additional information 906 may be information from the observations 812. The Supporting Data tab 808 further includes Benchmarking information 908. Benchmarking information 908 may include information relating to how the component performs or compares to various markers. For example benchmarking information 908 could include benchmarking for the component versus an industry standard, a goal, similar buildings, similar components, and/or historical data of the component. In various embodiments, benchmarking information 908 may include a visual representation of the benchmark comparison.

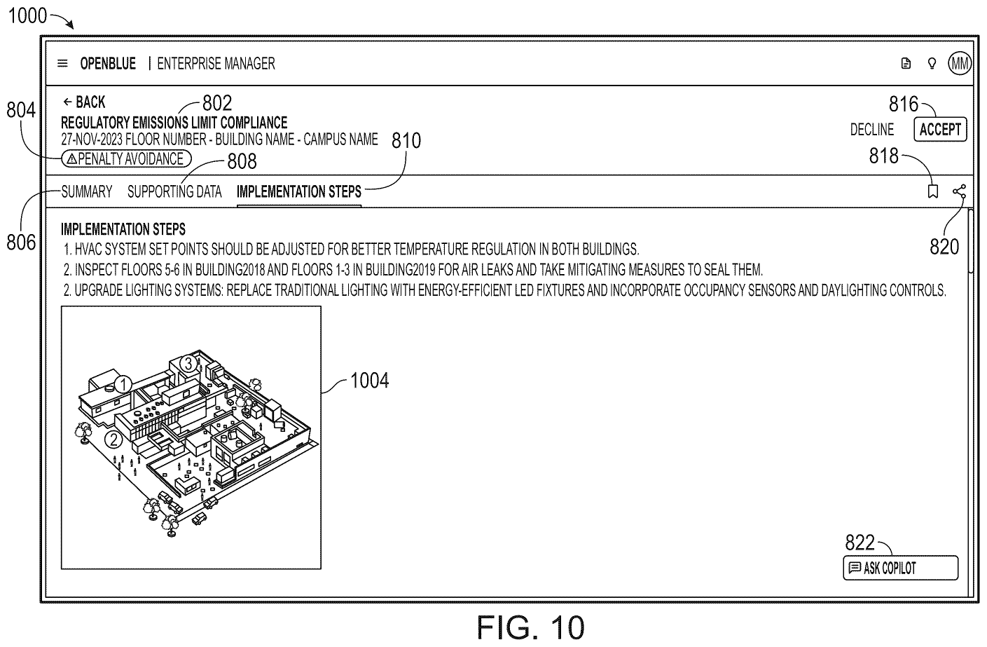

Referring now to FIG. 10, a UI 1000 is shown, according to an example embodiment. The UI 1000 is an expanded view of the same observation and recommendation of FIGS. 8 and 9 with the Implementation Steps tab 810 selected. As such, elements 802-810 and 816-822 are the same elements 802-810 and 816-822 described with respect to FIGS. 8 and 9.

Referring still to FIG. 10, the Implementation Steps tab 810 is selected. Under the Implementation Steps tab 810 is a list of implementation steps 1002. The implementation steps 1002 may be one or more steps or actions to take to change the operation of the component so that the observations of the component are resolved. The implementation steps 1002 may be actions to take to achieve the recommendations 814 of the Summary tab 806. The implementation steps 1002 may be one or more of digital or remote actions that can be performed off site, such as by an AI system or a remote agent (e.g., software updates, etc.), and physical actions that are performed on site, such as by a service technician (e.g., part replacement, etc.). Each implementation step 1002 may be a separate action to take, or may be one step of multiple steps that are taken in succession to implement the recommendations. In various embodiments, the Implementation Steps tab 810 may include a visual representation 1004. The visual representation may be an image or video that provides additional context to the implementation steps 1002. For example, the visual representation 1004 may be a pictorial representation of the component with labels indicating what parts of the component the implementation steps relate to. For example, if the component is a building and the implementation steps include three actions to be taken in different locations of the building, the visual representation 1004 may include a floorplan of the building with markers indicating the specific locations of the actions to be taken.

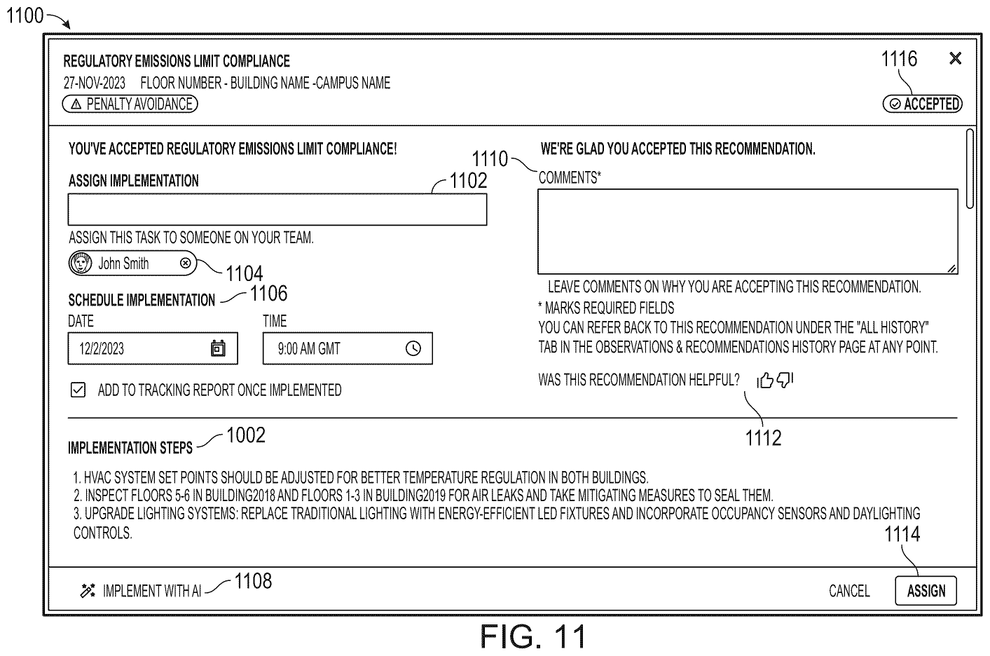

Referring now to FIG. 11, a UI 1100 is shown, according to an example embodiment. The UI 1100 may be displayed responsive to a user selecting the accept option 816 on any of the UIs 800, 900, or 1000 of FIGS. 8-10, respectively. The UI 1100 may include the implementation steps 1002 to be implemented.

The UI 1100 may display an option to assign the implementation of the steps to a specific user. A textbox 1102 may allow a user to enter a name, email, or other identifier of a user to assign the task. In various embodiments, entering text into the textbox 1102 may cause names of users matching the text in the textbox 1102 to appear. The user may select a user from the list to assign them the task. In various embodiments, the user may select a number of users to assign the task to. For example, if there are three implementation steps, three users may be assigned to each implement one of the steps. In various embodiments, responsive to selecting a user the implement the steps, an identifier 1104 may be shown to indicate that the implementation has been assigned. The assigned user may be a user that is to perform implementation of one or more of physical implementations and digital implementations.

The user may also schedule a date and time for implementation to occur, as shown by schedule implementation 1106. The user may select to add the implementation to a tracking report once the steps have been implemented. Thus, a report on the component may include a record of the implementation of the steps.

In various embodiments, the user can select option 1108 to implement with AI. The implement with AI button 1108 may cause an AI system to perform one or more actions that a user may otherwise perform with respect to the UI 1100 and the implementation of the implementation steps 1002. For example, responsive to selecting the implement with AI button 1108, an AI system may automatically assign and schedule implementation of any physical implementation steps. The AI system may have access to an organization tree, roles of various users, and schedules. The AI system may use these as inputs, in addition to information about the component (e.g., observations, location, etc.) to select an optimal user to perform implementation of the physical steps. For example, the AI system may determine an urgency of the implementation of the actions and assign a user with the soonest availability so that the actions are implemented as soon as possible. AI-based service scheduling is described in greater detail in U.S. Provisional Patent Application No. 63/470,122 filed May 31, 2023, the entirely of which is incorporated by reference herein. In various embodiments, upon selecting the implement with AI button 1108, the AI system may automatically push any digital actions. For example, if one of the implementation steps is a software update, the AI system may cause the software to automatically update. The AI system may also automatically add tracking of the observations and recommendations to a performance report of the component. In various embodiments, the user may be able to review the actions taken by the AI before accepting and assigning the implementation steps.

The UI 1100 may also include a textbox 1110 for comments. The user may be able to input comments explaining why they have accepted the recommendation and implementation steps. The AI system may utilize the user comments as feedback and input to determine future recommendations and implementation steps. The user may also be able to provide feedback on whether the recommendation is helpful using like and dislike buttons 1112. For example, if the user likes the recommendation, the user can select the thumbs up icon 1112.

Responsive to the implementation steps being scheduled and user feedback being written, the user may select option 1114 to assign the implementation of the actions. Prior to the assign button 1114 being selected, the status indicator 1116 may appear as “accepted,” indicating that the recommendation has been accepted but has not yet been implemented. Responsive to selecting the assign button 1114, the status indicator 1116 may appear as “implementing.”

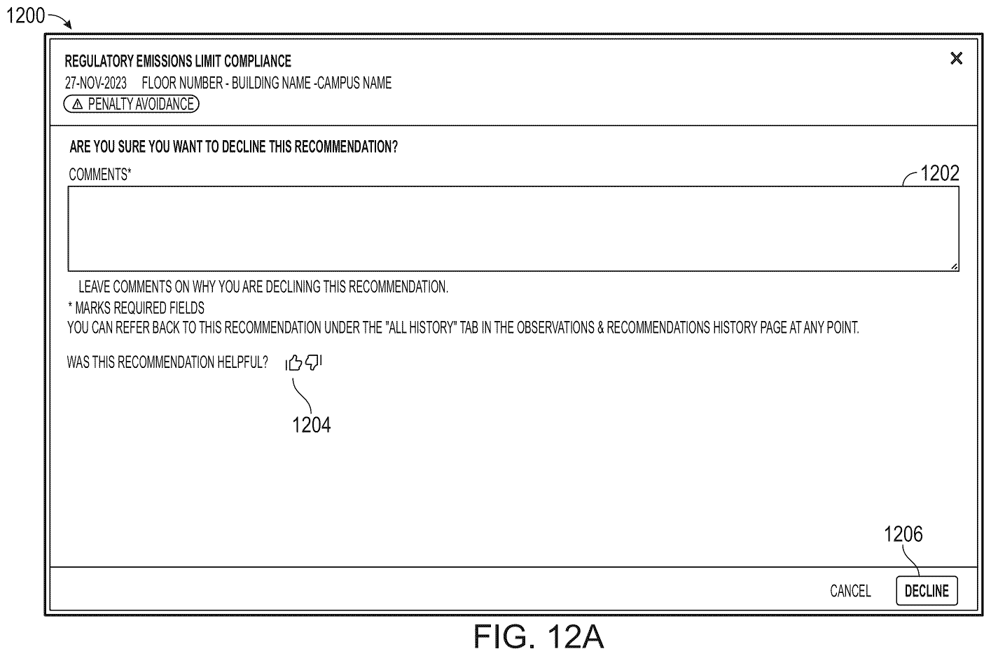

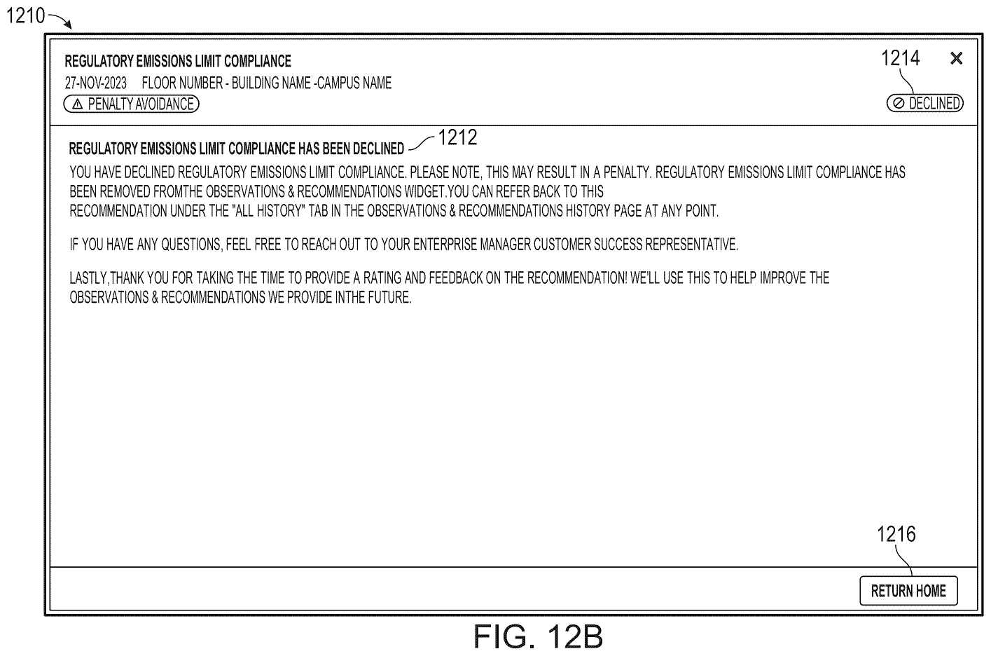

Referring now to FIG. 12A, a UI 1200 is shown. The UI 1200 may be displayed responsive to a user selecting the decline option 816 on any of the UIs 800, 900, or 1000 of FIGS. 8-10, respectively. The UI 1200 may include a comment box 1202. A user may input comments explaining why they opted to decline the recommendation. The UI 1200 may also include like and dislike buttons 1204. For example, if the user dislikes the recommendation, the user can select the thumbs down icon 1204. The AI system may utilize the user comments and like/dislike buttons 1204 as input to generate future recommendations. The user can select the decline option 1206 to decline the recommendation. Responsive to declining the recommendation, the observation and recommendation may be removed from the observations and recommendations widget 602 of the UI 600. The observation and recommendation may be able to be viewed in the All History tab 714 of the UI 700.

Referring now to FIG. 12B, a UI 1210 is shown. The UI 1210 may be displayed responsive to the user selecting the decline option 1206 on the UI 1200. UI 1210 may include text 1212 indicating that the user has declined the recommendation. The text may include implications of the user declining the recommendation, such as a potential penalty. The UI 1210 may include a status indicator 1214 showing “declined” to indicate that the user has declined the recommendation. The user may return to a home page (e.g., UI 600) responsive to selecting the return home button 1216.

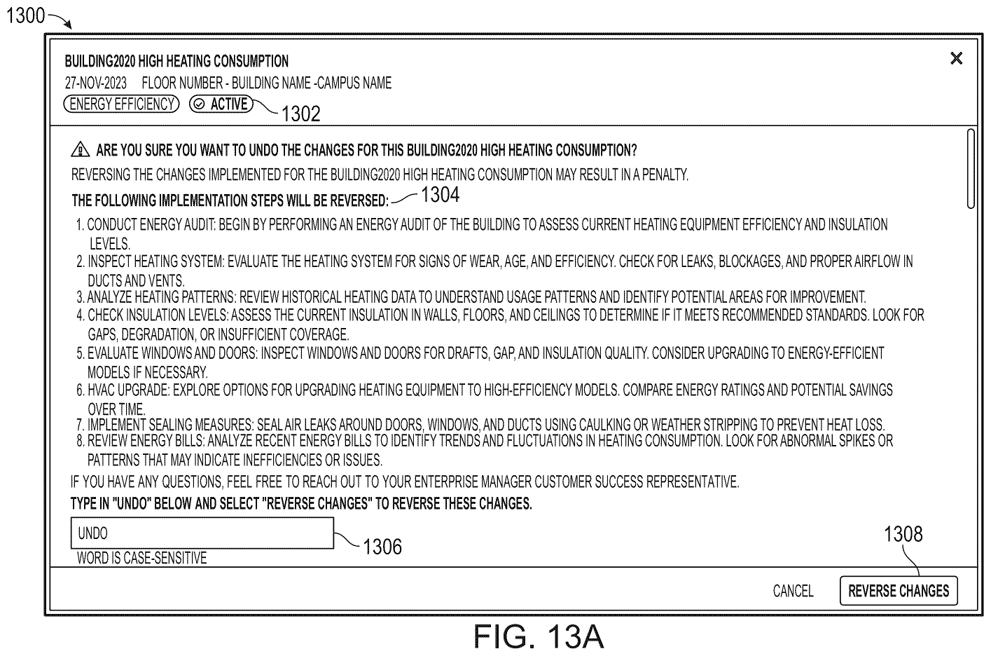

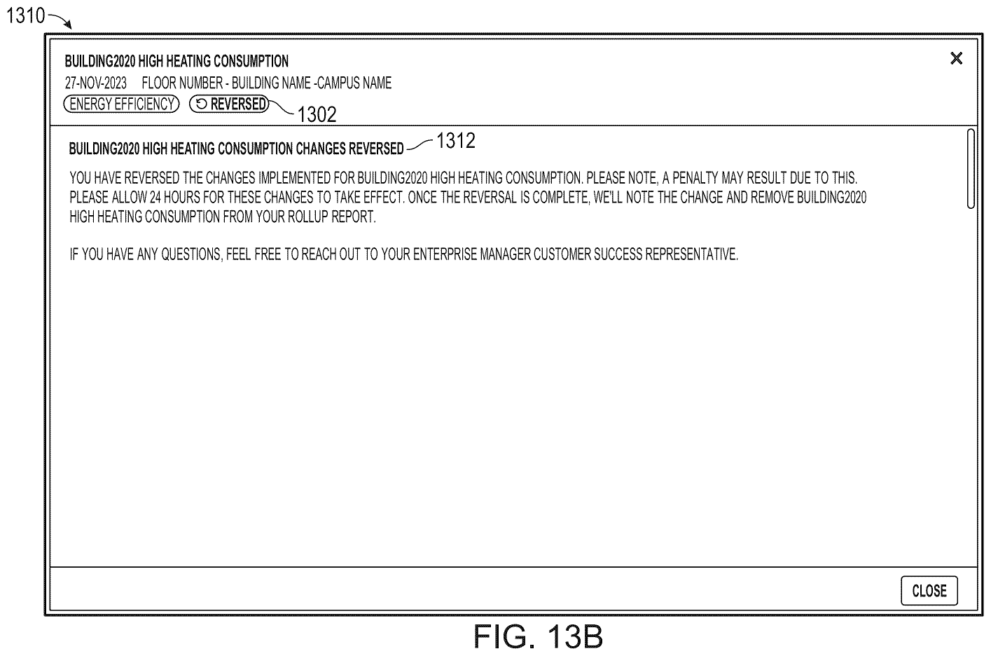

A user may no longer desire to implement a recommendation after previously accepting a recommendation. Thus, a user may select a widget 704 with an “active” status indicator 706 to reverse the implementation of the recommendation. Referring now to FIG. 13A, a UI 1300 is shown for reversing the implementation of a recommendation. The status indicator 1302 may indicate that the recommendation is active (i.e., the recommendation has been implemented). The UI 1300 may include a list 1304 of implementation steps to be reversed. The items in the list 1304 may be the implementation steps 1002 and/or the recommendations 814.

The UI 1300 may include a text box 1306. The UI 1300 may prompt the user to type in a word, such as “undo,” as a manual confirmation that the implementation of the recommendation is to be reversed. Upon entering the text into the text box 1306, the user can select the reverse changes option 1308 to complete the reversal of the recommendation implementation. Upon selecting option 1308, a UI 1310, shown in FIG. 13B, appears. The UI 1310 shows the status indicator 1306 as indicating a “reversed” status. The UI 1310 also includes text 1312 indicating that the implementation has been reversed. In various embodiments, upon reversing the implementation, one or more users may receive a notification to reverse physical actions that were implemented. Digitally implemented actions may be reversed by an AI system.

Referring now to FIG. 14A, a first embodiment of a UI 1400 for sharing an observation and recommendation is shown. The UI 1400 may include a search box 1402 in which a user can search for a second user to share the observation and recommendation with. Upon typing the name of a user to share the data with, the user's name may appear in section 1404. Multiple users may be selected to have the observation and recommendation shared with them. Referring now to FIG. 14B, a second embodiment of a UI 1410 for sharing an observation and recommendation is shown. The UI 1410 may include text 1412. The text 1412 may be or include the observations 812 and recommendations 814 generated and displayed in the summary tab 806 of the UI 800. A user that is selected to have the observation and recommendation shared with them may receive and be able to view the text 1412. The user sharing the observation and recommendation may add additional comments in a comment box 1414. The users receiving the shared content may also be able to view the comments left by the sharing user in comment box 1414.

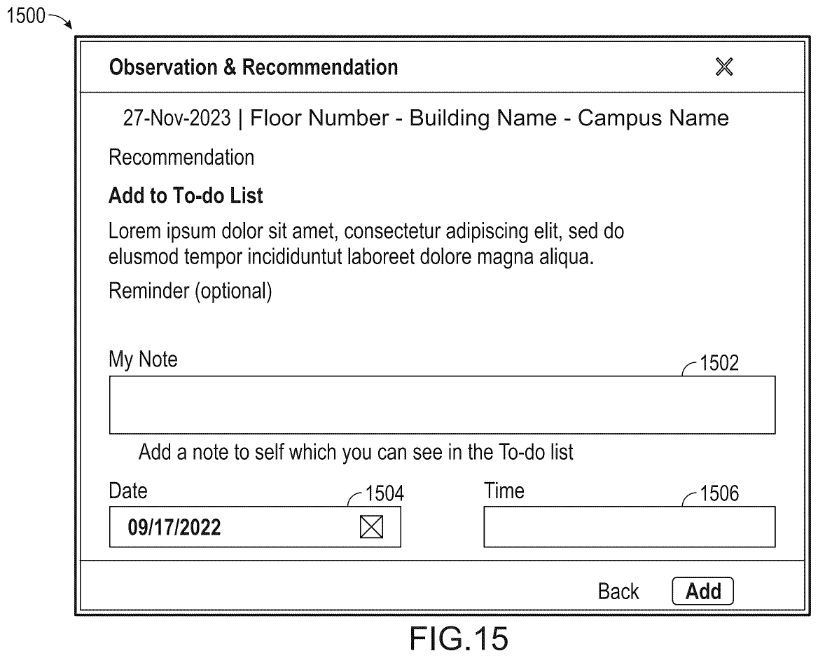

Referring now to FIG. 15, a UI 1500 is shown for adding the observation and recommendation to a to-do list. The user may select an option to add one or more actionable items of the observation and recommendation (e.g., one or more implementation steps) to a to-do list. The user may add a note or comments using text box 1502. The user may also add a date and time at which the item should be complete using boxes 1504 and 1506, respectively.

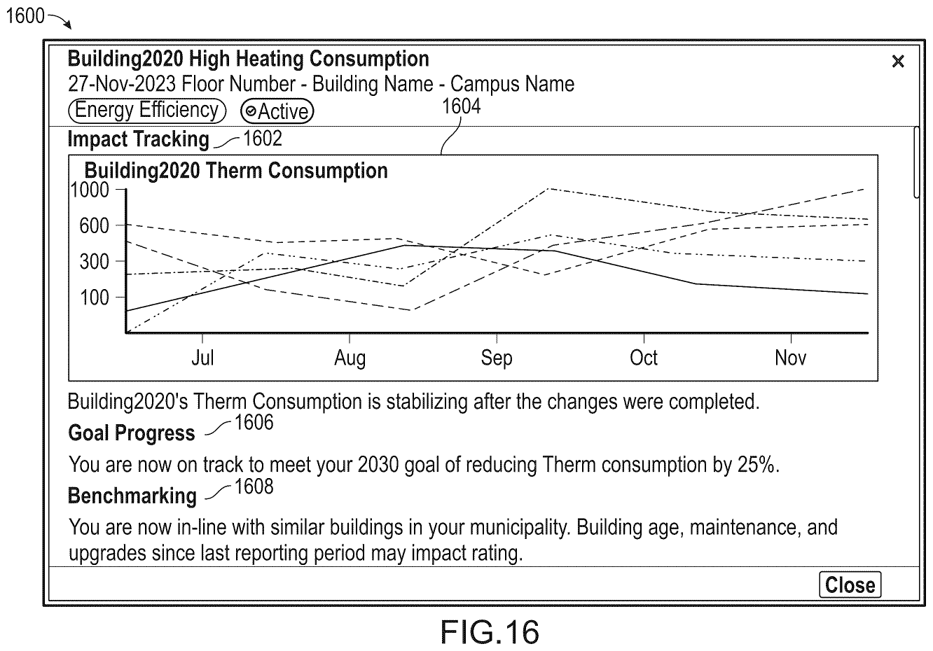

Referring now to FIG. 16, a UI 1600 of an active observation and recommendation is shown, according to an example embodiment. The UI 1660 may be for an observation where the user has accepted the recommendation and the implementation steps have been implemented. The UI 1600 may include an impact tracking section 1602. The user may be able to view data or information indicating how the implementation of the recommendation has impacted the performance of the component. In various embodiments, the impact tracking section may include a graph 1604. For example, in FIG. 16, the graph 1604 is a line graph indicating thermal consumption over time. The user may view the graph 1604 and see that thermal consumption has decreased responsive to implementing the recommendation.

The UI 1600 may also include a goal progress section 1606. The goal progress section 1606 may include an indication of how the implementation of the recommendation has affect progress towards a goal. For example, a user may have a goal for a component, such as a total emissions, total consumption, or cost reduction. The goal progress section 1606 generate text indicating progress on reaching the goal. The progress toward reaching the goal may be determined by, for example, an AI system analyzing historical data of the component. The UI 1600 may also include a benchmarking tab 1608. The benchmarking tab 1608 may be similar to the benchmarking tab 908 of the UI 900. For example, the benchmarking tab 1608 may include information relating to how the component performs or compares to various markers (e.g., versus an industry standard, a goal, similar buildings, similar components, and/or historical data of the component).

Referring now to FIG. 17, a UI of a chatbot 1700 is shown, according to an example embodiment. The chatbot 1700 may be or include one or more large language models (LLMs) or other artificial intelligence-based chatbots. The chatbot 1700 may appear responsive to a user selecting the chatbot icon 822 on any of the UIs 800-1000. The chatbot 1700 may be configured to hold a conversation with the user. For example, responsive to the user selecting the chatbot icon 822, the chatbot 1700 may appear. The chatbot 1700 may send an initial message 1702. The message 1702 may ask the user what assistance is needed. The user can respond with a message 1704. The message 1704 may be selected from a number of prompts 1706 or typed in using chat box 1708. The prompts 1706 may be prepopulated. The prompts 1706 may be contextual based on the observation and response that the user is currently viewing. The prompts 1706 may help the user begin a conversation and provide guidance. The prompts 1706 may be selectable by the user. Responsive to the user sending a message 1704, the chatbot 1700 may respond with a message 1710. The message may be a text-based response. The message 1710 may also include a visual data representation. For example, the message 1710 may include a written answer and a graph to support the written answer. In some embodiments, the generation of the text-based response responsive to a prompt from a user is described in greater detail in U.S. Provisional Patent Application No. 63/529,582 filed Jul. 28, 2023, the entirely of which is incorporated by reference herein.

In various embodiments, the chatbot 1700 may be an embedded LLM that has access to one or more datasets. For example, the chatbot 1700 may have access to information related to some or all of the faults, predicted faults, and related information for each piece of building equipment. A user may be able to interact with the chatbot 1700 and receive information regarding any piece of building equipment. For example, the user may be chatting with the chatbot while viewing observations and recommendations for a chiller. The user may be able to query the chatbot 1700 about any piece of building equipment, not just the chiller, and the chatbot 1700 may be able to retrieve information about the equipment included in the query.

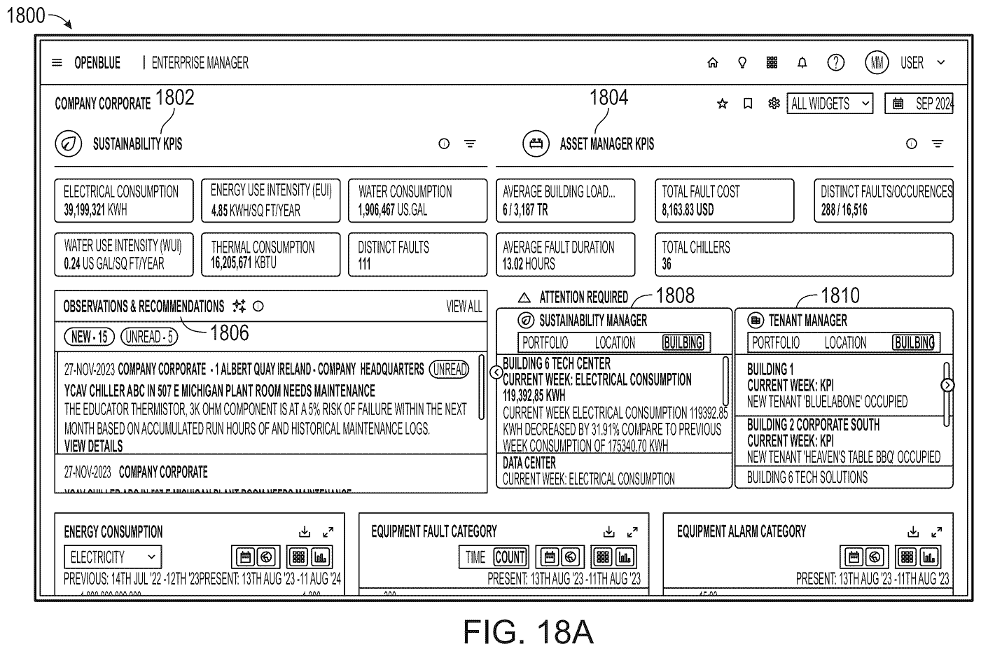

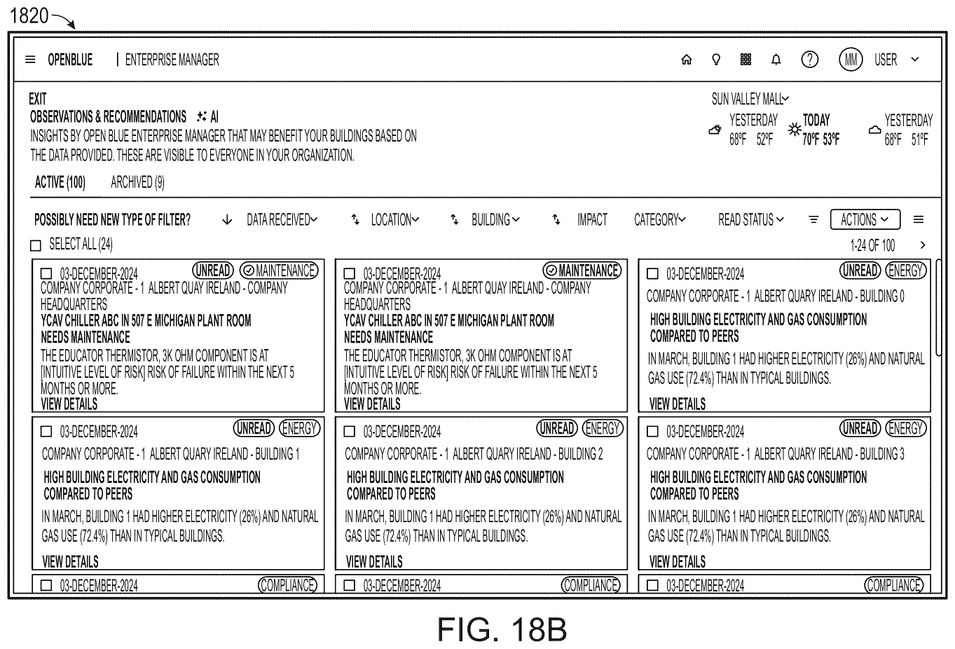

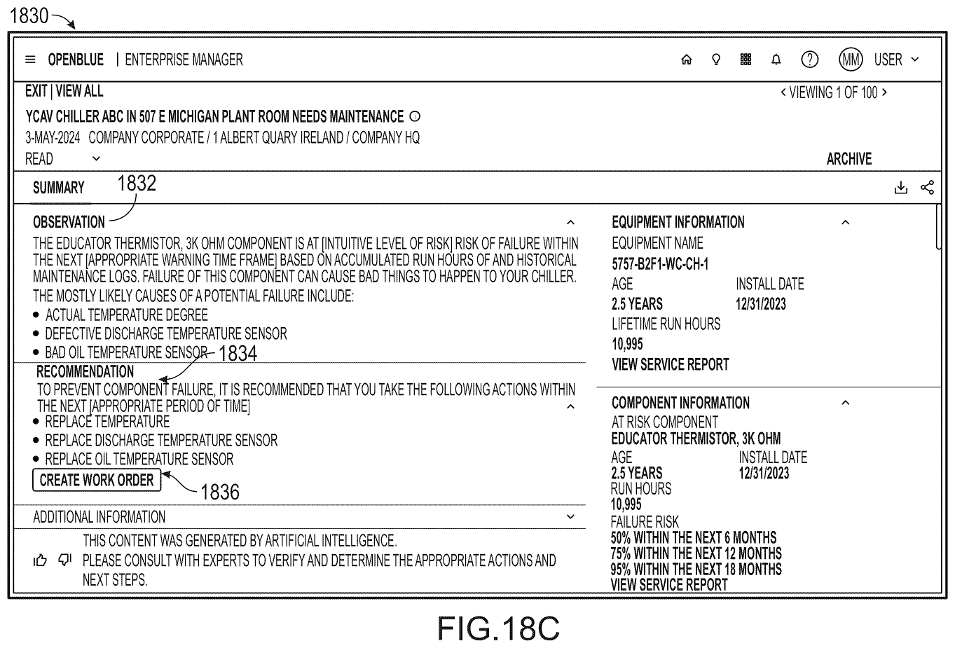

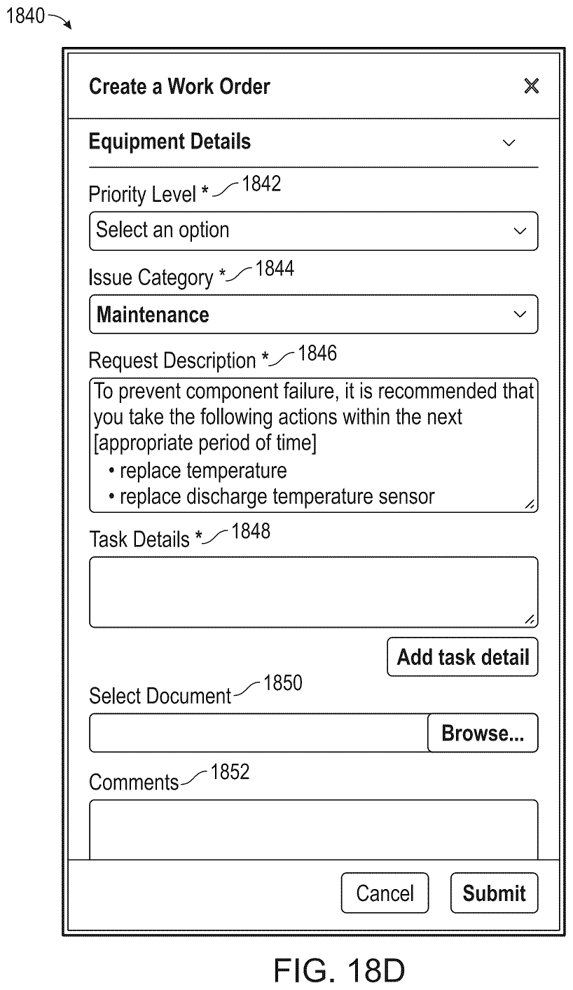

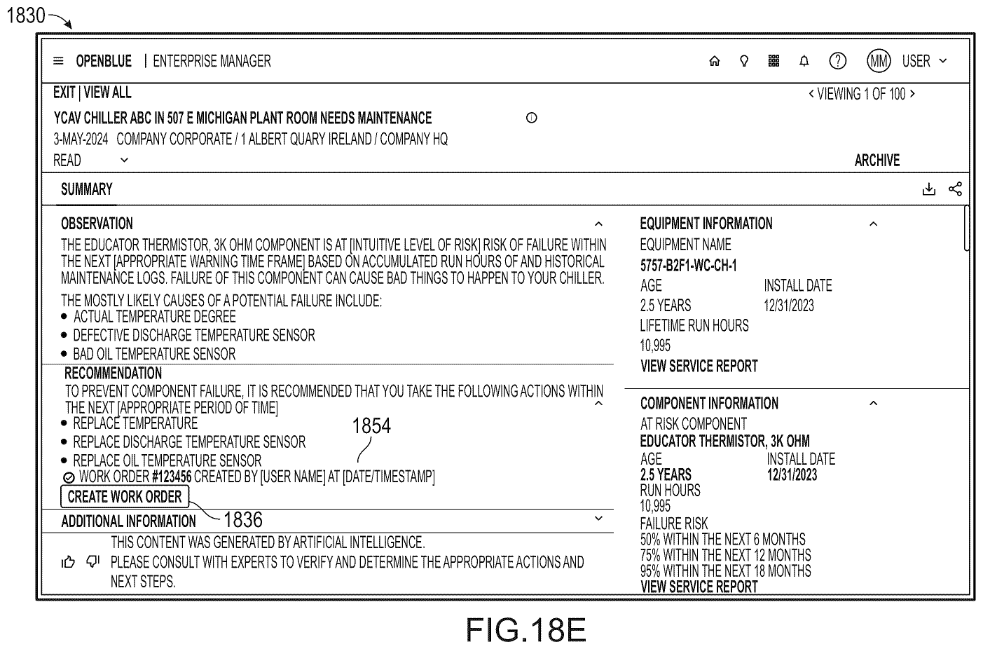

Referring now to FIGS. 18A-18E, a plurality of user interfaces are shown, according to an example embodiment. The user interfaces may be the same as or similar to, include similar components or features, facilitate similar processes, etc. as the user interfaces described with respect to FIGS. 6-17.

Referring specifically to FIG. 18A, a user interface (UI) 1800 is shown, according to an example embodiment. The UI 1800 includes a plurality of key performance indexes (KPIs). For example, the UI 1800 includes sustainability KPIs 1802 and asset manager KPIs 1804. As shown in FIG. 18A, sustainability KPIs 1802 may include various performance metrics or measurements related to sustainability performance of one or more pieces of building equipment. For example, KPIs may include electrical consumption, energy use intensity (EUI), water consumption, water use intensity (WUI), thermal consumption, a number of faults, and the like.

Asset manager KPIs 1804 may include information relating to faults of one or more assets (e.g., pieces of building equipment, equipment in a building, equipment belonging to a particular user or customer, etc.). For example, asset manager KPIs 1804 may include a total cost of all asset faults, a number of distinct faults or occurrences of faults, an average duration of a fault (e.g., a time between a fault occurring and the fault being resolved), a total number of assets (e.g., pieces of building equipment), and the like.

The UI 1800 may also include an observations and recommendations widget 1806. The observations and recommendations widget 1806 may be selectable to generate a user interface displaying observations relating to various equipment faults and recommendations on how to resolve the faults. The widget 1806 may include a feature indicating a number of observations and recommendations that have been read (e.g., opened, acknowledged, etc.) and unread. The observations and recommendations widget 1806 may be scrollable to view a plurality of currently active faults.

The UI 1800 may also include a sustainability manager widget 1808. The sustainability manager widget 1808 may include sustainability information. The sustainability information may be displayed for a particular building, a particular location (e.g., a campus including a plurality of buildings, etc.), a portfolio (e.g., of selected equipment, locations, buildings, etc.), etc. The UI 1800 may further include a tenant manager 1810, which indicates a tenant of each building, location, portfolio, etc. The UI 1800 may further include a plurality of additional widgets, such as an energy consumption widget, an equipment fault category widget, an equipment alarm category widget, etc.

In various embodiments, the UI 1800 (and/or any of the user interfaces shown and described herein) may be configurable and customizable. For example, a user viewing the UI may select a particular persona (e.g., a building supervisor, an energy manager, a chiller service technician, etc.). The user interface may be configured to include and display information relevant to the selected persona. For example, if a user indicates that they are to view the user interface through an energy manager persona, the UI may be configured to include widgets that include information relevant to energy use, consumption, savings, etc. The user may be able to view one or more dashboards that display information relevant to the selected persona, such as specific dashboards, graphs, faults, etc. Each UI may further include a plurality of tabs such that a user can switch between various personas easily. In some embodiments, a user can generate a custom dashboard including custom (e.g., user-selected) information corresponding to a custom (e.g., user-selected) persona.

Referring now to FIG. 18B, a user interface 1820 is shown, according to an example embodiment. The UI 1820 is shown as an observations and recommendations widget. The UI 1820 may be displayed responsive to selecting the observations and recommendations widget 1806 on the UI 1800. The UI 1820 may be the same as or similar to the UI 700 described above with respect to FIG. 7A. In addition to the features described with respect to FIG. 7A, the UI 1820 may include an indication of active faults and archived (e.g., resolved) faults. Each widget corresponding to a particular fault (and observation and recommendation) may include an indication of whether the fault has been read or is unread, as well as an indication of a type of fault (e.g., a fault requiring maintenance, an energy-related fault, etc.).

Referring now to FIG. 18C, a user interface 1830 is shown, according to an example embodiment. The UI 1830 may be displayed responsive to selecting a widget corresponding to a particular fault on the UI 1820. The UI 1830 may be similar to the UI 800 shown and described with respect to FIG. 8. For example, the UI 1830 includes an observation 1832 indicating one or more observations, facts, pieces of data, etc. relating to the particular fault. The UI 1830 further includes a recommendation 1834 indicating one or more recommendations for resolving the fault.

In addition to the features described with respect to FIG. 8, the UI 1830 may further include equipment information, such as equipment name, an equipment age, a date of equipment installation, a total number of equipment running hours, etc. The UI 1830 may further include an option for a user to select to view a service report for the equipment. Similarly, the UI 1830 may include component information. The component equipment may indicate a component of the equipment that is experiencing the fault or is at risk for experiencing a fault, an age of the component, an installation date of the component, a number of total run hours of the component, and a likelihood or probability that the component experiences a fault within a predetermined amount of time in the future.

The UI 1830 may further include a work order icon 1836. Selecting the icon 1836 may allow a user to create a work order to cause a service technician to service the equipment to resolve a fault or prevent a fault from occurring. The work order is described in greater detail with respect to FIG. 18D.

Referring now to FIG. 18D, a user interface 1840 for creating and submitting a work order is shown, according to an example embodiment. The UI 1840 may be displayed (e.g., as a pop up, as a separate interface or page, etc.) responsive to selection of the work order icon 1836 on the UI 1830. When creating a work order, a user may indicate a priority level 1842 of the work order (e.g., according to a severity or importance of addressing the fault). The user may also select an issue category 1844 that indicates a type of fault experienced by the equipment (e.g., maintenance-related fault, an energy-related fault, etc.).

The work order UI 1840 may also include a description 1846 that describes the fault experienced by the equipment, actions to be taken to resolve the fault, etc. For example, in some embodiments, the description 1846 may be auto populated to include the information included recommendation 1834. The UI 1840 may further include task details 1848. The task details 1848 may include details for servicing the equipment, details about the equipment or faulty component that is important to know to be able to effectively service the equipment, etc.

The UI 1840 may further include an option to upload a document 1850. For example, a user may upload a service report relating to the equipment that may be used by a service provider to better service the equipment. Further, the UI 1840 may include a section to include additional comments 1852.

Referring now to FIG. 18E, the UI 1830 is shown, according to another example embodiment. Specifically, the UI 1830 shown in FIG. 18E depicts the UI 1830 after a work order has been created. The UI 1830 includes an indication 1854 that the work order has been created. Specifically, the UI 1830 may indicate a name of a user that has created the work order, a date and time at which the work order was created, and an identification of the work order (e.g., a work order number, etc.).

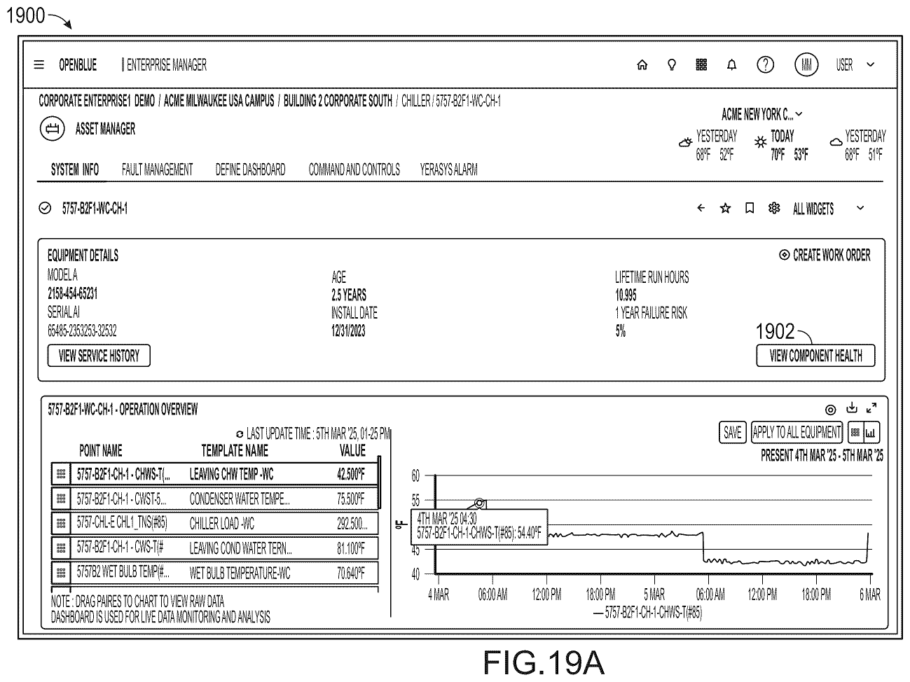

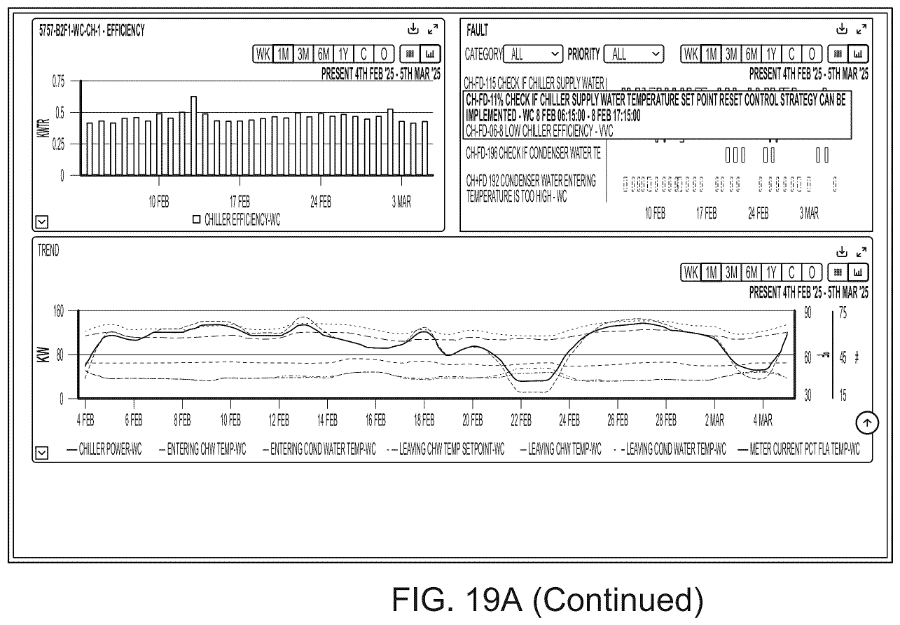

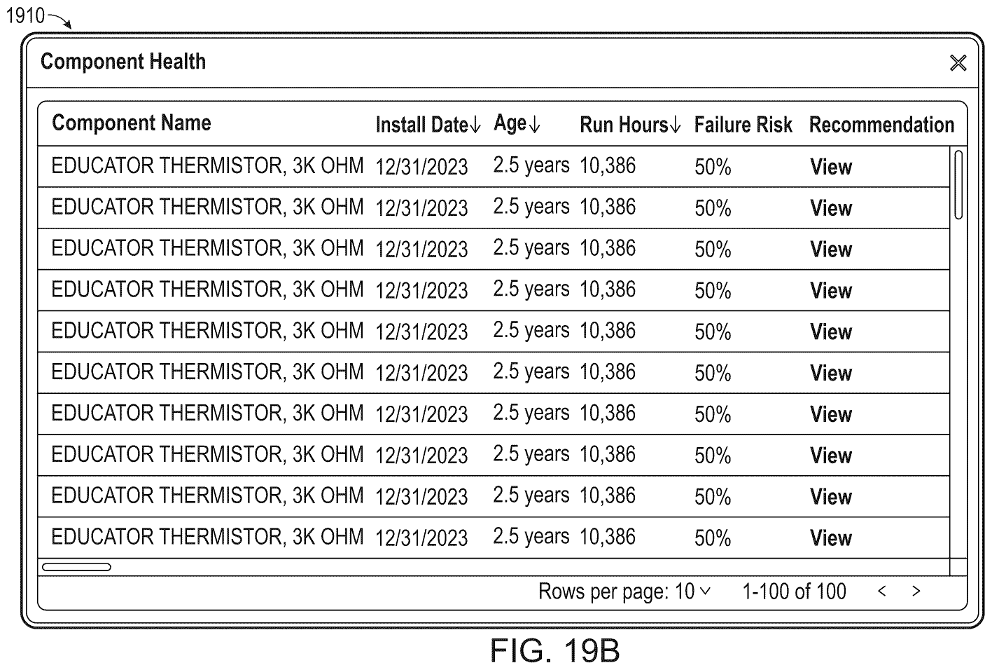

Referring now to FIG. 19A, a user interface 1900 is shown, according to an example embodiment. The UI 1900 displays an asset manager. The asset manager UI 1900 includes a plurality of operations and performance metrics for a particular asset (e.g., piece of equipment, etc.). For example, the UI 1900 includes equipment details such as a model number, a serial number, an age, etc. The UI 1900 includes an icon 1902 that is selectable to generate a user interface to display a health of a particular component.

The UI 1900 may further include a plurality of charts and graphs. For example, the UI 1900 may include graphs indicating various performance metrics, such as a water temperature in a piece of equipment, a load value, etc. Graphs may further include, for example, efficiency data, fault data, trends over time, etc.

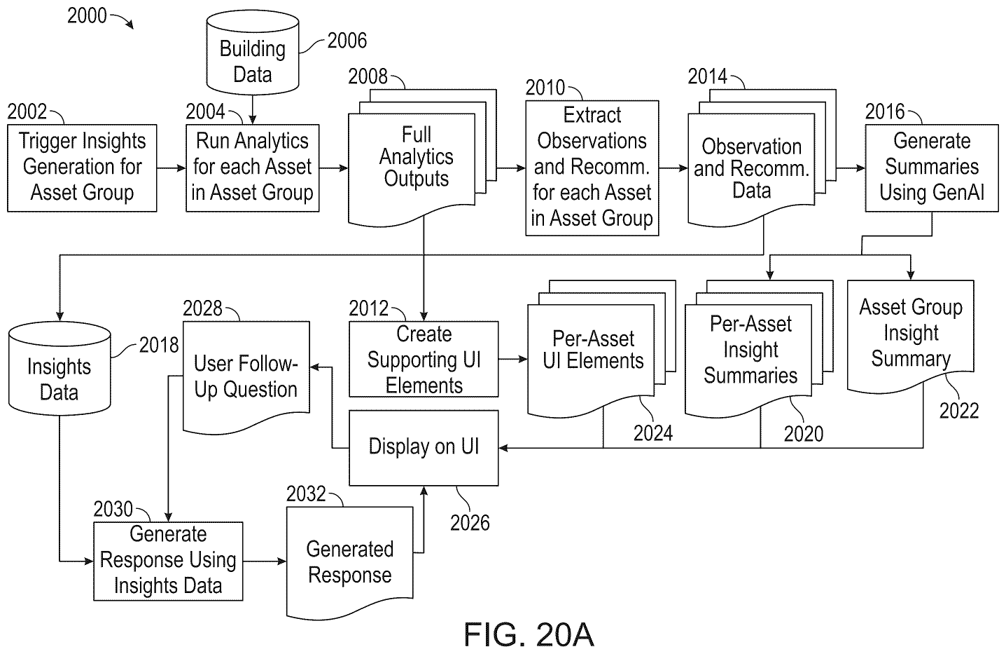

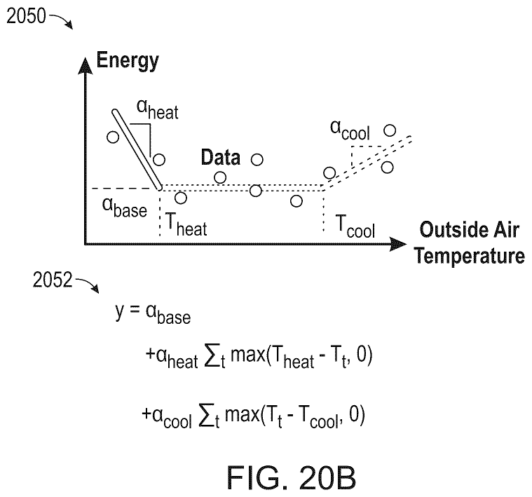

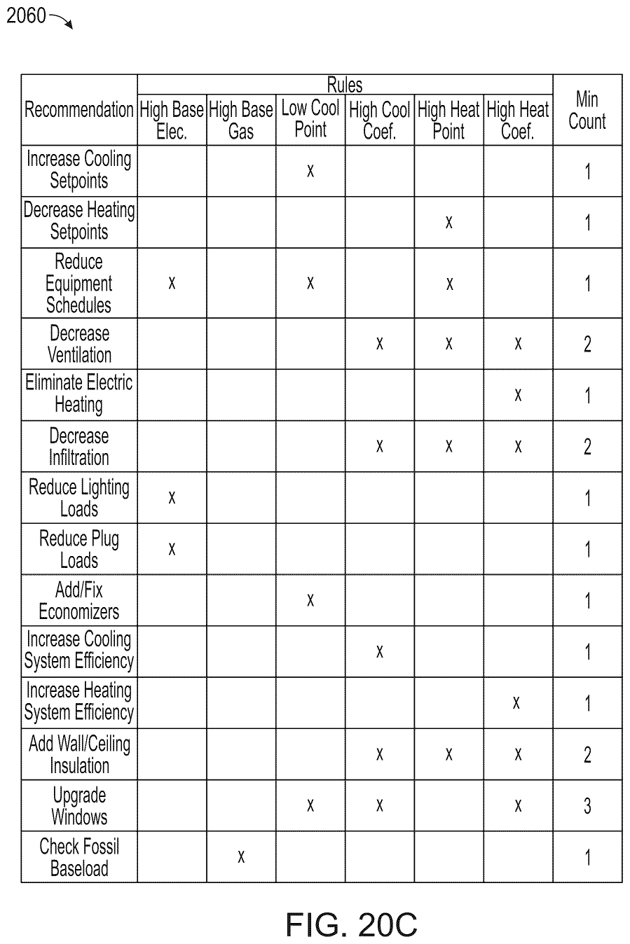

In various embodiments, a user may be able to generate an insight report. The report may include one or more piece of information included in the UI 1900 (and/or any other UIs described herein). The insight report may be a summary of the performance of a particular building, campus, etc. The report may include asset-level and space-level performance data. For example, the report may include a list of equipment or assets that are the most inefficient. For example, as will be discussed in greater detail with respect to FIG. 20, one or more LLMs may receive equipment operating data and rank a plurality of faults based on one more metrics, such as based on a cost of the fault, a level of inefficiency caused by the fault, etc. The ranked faults may be included on the report. An LLM may be used to generate a similar ranking for particular spaces (e.g., different rooms within a building, etc.). The LLM may further analyze these ranked faults, equipment, spaces, etc. and identify patterns in operating conditions that may be causing the faults or inefficiencies. These patterns may be explained and included in the insight report.

Referring now to FIG. 19B, a chart 1900 showing component health is shown, according to an example embodiment. The chart 1900 may be displayed responsive to a user selecting the icon 1902 on the UI 1900. The chart 1900 may display heath metrics for a plurality of components associated with one or more pieces of building equipment. For example, for a single piece of building equipment (e.g., a chiller), information regarding each component within the equipment, such as a date of installation, an age, a total number of running hours, a failure risk, etc., may be displayed. Further, a user may be able to view a recommendation for servicing each particular piece of building equipment.

Referring now to FIGS. 20A and 20B, an AI system is shown. The AI system may generate the observations and recommendations. The AI system may utilize or be, for example, a model, algorithm, or other system. FIG. 20A illustrates a flow diagram is shown for a method 2000 of generating observations and recommendations, according to an example embodiment. FIG. 20B illustrates a five-parameter regression model. In various embodiments, the AI system may utilize the five-parameter regression model. The user interfaces generated and displayed may be agnostic to the algorithms and/or models generating the observations, recommendations, and/or any additional insights. The AI system may utilize, for example, rule-based logic, quantitative machine-learning models, or generative artificial intelligence.

At step 2002, the generation of insights for an asset group is triggered. The asset group may be or include, for example, a number of pieces of building equipment. The pieces of building equipment may be grouped or related to one another. For example, an asset group may include pieces of building equipment for a certain floor of a building. At step 2004, analytics may be run for each asset in the asset group (e.g., analytics are run for each piece of building equipment in the group of pieces of building equipment operating on a floor of a building). The analytics may be run using building data 2006. Building data 2006 may include, for example operating parameters, usage parameters, costs, etc. for the pieces of building equipment. Full analytics outputs 2008 are generated as an output of step 2004. The analytics outputs may be related to the building data 2006 used to perform the analytics at step 2004. The analytics outputs may include information about how the equipment is performing.

The analytics run at step 2004 may be performed by utilizing one or more LLMs. For example, the FDD layer may receive and analyze raw data (e.g., building data 2006) to identify a plurality of faults. The FDD layer 416 therefore performs a quantitative analysis of the building data 2006. For example, the FDD layer 416 may perform time series forecasting, ranking and aggregation, rule based logic, etc. to analyze the building data 2006. The FDD layer 416 may transmit the data to the LLMs. The LLMs may then transform the data (e.g., results of the quantitative analysis) into a plain text format. These plain text formatted results may be used in subsequent steps of the method 2000. For example, the plain text results may be used to generate UI elements to be displayed on any of the user interfaces described herein.

In other embodiments, the FDD layer 416 may identify the faults occurring or likely to occur in one or more pieces of building equipment and transmit the information to the LLMs. The LLMs may then perform or apply a ranking and/or prioritization of the faults and/or any other quantitative analysis of the data. For example, a plurality of faults may be identified by the LLMs. The LLMs may rank the faults according to, for example, an amount of impact on the building, piece of equipment, component of the equipment (e.g., in terms of cost, energy efficiency, energy use, water use, etc.), and the like.

The faults may be ranked by weighting one or more parameters used to identify the fault. For example, the faults may be ranked by weighting one or more pieces of building data 2006. Parameters that are relevant to the feature that the faults are being ranked according to may be weighted more heavily than irrelevant parameters. For example, in some embodiments, the faults may be ranked by a cost associated with the fault (e.g., a cost associated with not servicing the fault or savings associated with servicing the fault). As such, data or parameters relevant to cost may be weighted more heavily than parameters not relevant to cost. In various embodiments, the faults may be ranked by time, impact, etc. Further, in some embodiments, the LLMs may utilize forecasted emissions data to generate such rankings and fault prioritization. The LLMs may identify, rank, and/or prioritize a subset of all of the identified faults. For example, the FDD layer 416 may identify 1000 faults occurring in a plurality of pieces of equipment in a building. The LLMs may identify a subset of these faults and may rank and prioritize the subset. For example, the LLMs may rank 5 of the faults 10 of the faults, 50 of the faults, etc., thereby reducing processing power that would otherwise be utilized to rank and prioritize all of the faults identified by the FDD layer 416. The LLMs may also generate additional information, including observations and recommendations associated with each fault.

At step 2010, observations and recommendations are extracted for each asset in the asset group. The observations and recommendations may be extracted from the full analytics outputs generated at step 2008. For example, the full analytics output from the LLMs may include more information than observations about the performance of the equipment and recommendations on how to improve performance. Observations and recommendation data 2014 may be generated as an output of step 2010. At step 2016, summaries of the observations and recommendations may be generated using generative artificial intelligence. The observations and recommendation data 2014 may be used as an input by the generative AI model to generate the summaries. The summaries generated at step 2016 may be per-asset insight summaries 2020 or asset group insight summaries 2022. Per-asset summaries 2020 may be generated for individual pieces of building equipment in a group (e.g., a single chiller in a group of equipment operating on a floor of a building). Asset group insight summaries 2022 may be generated for the pieces of building equipment in a group and may describe the operation of the pieces of building equipment as a unit.

Referring again to full analytics outputs 2008, the outputs may be used to create supporting UI elements at step 2012. The outputs not relating to observations and recommendations may be supporting data displayed on the UI (e.g., emissions data 602 on the UI 600). The per-asset insight summaries 2020, asset group insight summaries 2022, and non-observation and recommendation analytics outputs 2008 may be per-asset UI elements 2024. At step 2026, the per-asset UI elements 2024 may be displayed on a UI. For example, the per-asset UI elements 2024 may be displayed on the UI 600. The generated UI may include a user follow-up question 2028. For example, a user may ask a question to the chatbot 1700 or leave a comment in a text box on one of the UIs described above.

One or more supporting UI elements and/or per-asset UI elements may be generated by one or more LLMs. For example, as described above, one or more LLMs may rank and prioritize building equipment faults according to, for example, an importance of addressing the faults. The LLMs may also receive or utilize information about the relationships between various pieces of building equipment, interactions between pieces of building equipment, the effects of pieces of building equipment on various spaces or buildings, etc. This information, in addition to the ranked fault data, may be used to generate one or more hyperlinks on the generated UI. For example, for a particular piece of building equipment experiencing a fault, the LLM may generate one or more observations and recommendations. The LLM may include, in the recommendation on how to service the fault, an embedding or hyperlink to an asset (e.g., component of the equipment, piece of equipment causing a building-wide fault, etc.) that may be determined to be causing the fault. For example, a chiller may be experiencing a fault due to a problem exercised by another piece of equipment. The LLM may identify such a connection between the two faults, and a hyperlink leading to an observations and recommendations page for one piece of equipment may be displayed on the observations and recommendations page for the other piece of equipment. This may facilitate faster fault diagnostics, analysis, and servicing, thereby reducing equipment downtime and improving building efficiency.

Referring again to the observations and recommendations data 2014, the data may be stored in an insights database 2018. The insights database 2018 may store information and historical data of current and previously generated observations and recommendations. At step 2030, a response may be generated using the insights data 2018. The response may be, for example, one or more steps or actions to implement to follow the generated recommendations. The user follow-up question 2028 may be used as a input to the generated response at step 2030. Responsive to step 2030, a response 2032 is generated. The response may be displayed on the UI at step 2026.

Referring now to FIG. 20B, an example regression model used by the AI system is shown, according to an example embodiment. The five-parameter regression model be less general than a forecasting model due to fewer inputs to the regression model. In various embodiments, the inputs to the regression model may have physical interpretations. The parameters of the regression model may fit hierarchically. For example, two non-linear parameters may by at a first or “top” level via derivative-free optimization. Three linear parameters may be at a second or “bottom” level via linear regression.

Graph 2050 illustrates an example representation of the regression model. Specifically, the graph 2050 shows an exemplary outside air temperature vs. energy chart. The regression model may be governed by an equation 2052 that considers the parameters of the regression model. For example, the equation 2052 considers base, heating, and cooling parameters. In various embodiments, parameters of the equation 2052 may be excluded if the data is not significant. For example, the heating and cooling parameters may be excluded if there is not at least 1% R² improvement and/or 1% coefficient of the variation of the root mean square error (CVRMSE) improvement. The R² value in a regression model may indicate how well the data fits the regression model. Thus, if it is determined that the inclusion of the heating and/or cooling parameters of the model do not improve the R² and cause a better fit of the data to the model, the parameters may be excluded. The CVRMSE may be defined as the ratio of the root mean square error to the mean of the target variable. The CVRMSE may indicate stability or instability in an observed relationship between variables in a baseline dataset. The CVRMSE may be one of a plurality of coefficients of variation and may measure variation of errors in a regression model, normalized by the mean of the target variable. In various embodiments, the five-parameter regression model may try all possible combinations of included and excluded terms to determine and utilize a “best” model.

The logic used by the AI system to generate the recommendation is described herein. A user may provide “benchmark” values of regression model parameters. For example, the benchmark values may reflect performance for a typical building of the type of building having recommendations generated. The benchmark values may be obtained from, for example, an API or a dataset. Fit regression model parameters may be compared against the benchmark values. Based on which parameters are above and/or below the benchmark values, specific recommendations may or may not be issued. FIG. 20C illustrates the recommendation logic 2060 used to determine recommendations.

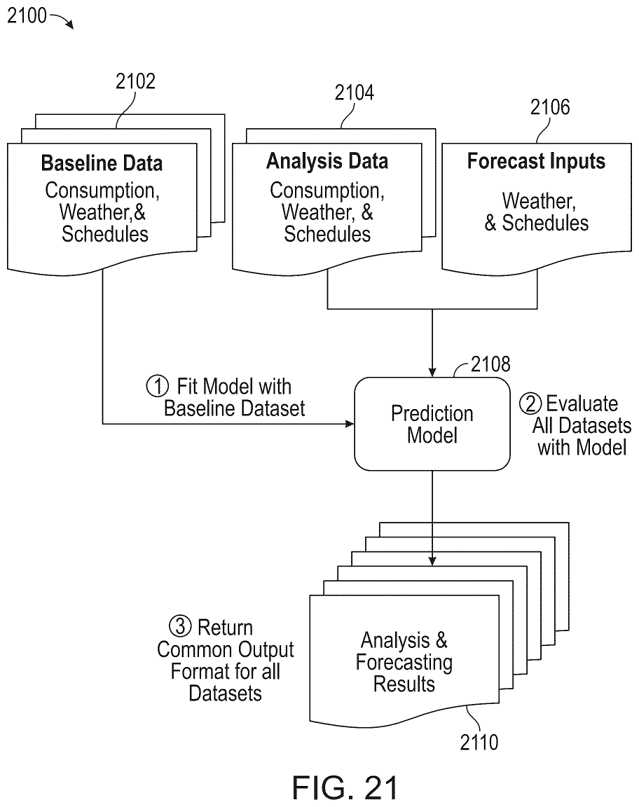

Referring now to FIG. 21, a block diagram 2100 is shown for a prediction model. Baseline data 2102, analysis data 2104, and forecast inputs 2106 may be used as inputs to the prediction model 2108. Baseline data 2102 may include, for example, baseline consumption data, weather data, equipment operating schedules, etc. for one or more pieces of equipment. Analysis data 2104 may include operating data (e.g., consumption, weather, scheduling, etc.) for the equipment based on how the equipment is currently running or has previously run. Forecast inputs 2106 may be predicted future operation of the equipment.

The baseline data 2102, analysis data 2104, and forecast inputs 2106 may be input to the prediction model 2108. The prediction model may be fit with the baseline data 2102. In various embodiments, each data set may each be evaluated with the prediction model 2108. The prediction model 2108 may utilize a statistical regression model that is fit on demand (e.g., responsive to received data). Inputs to the model may be, for example, weather data, usage data, cost, consumption data, etc. Outputs of the prediction model 2108 may be, for example, a range of predicted consumption for the equipment. As an output of the prediction model 2108, analysis and forecasting results 2110 are generating. A common output format may be returned for each of the baseline data 2102, analysis data 2104, and forecast inputs 2106.

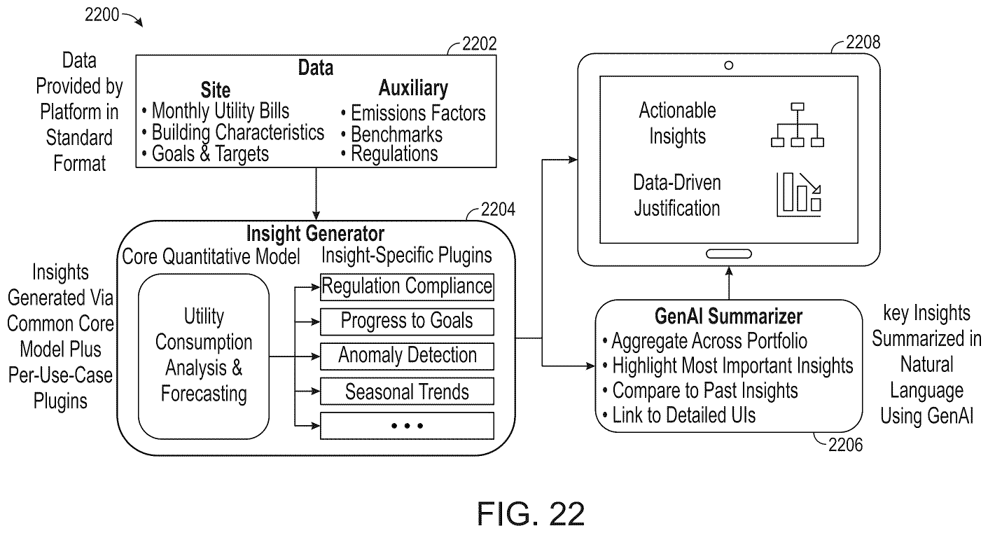

Referring now to FIG. 22, a block diagram 2200 for a generative artificial intelligence system is shown, according to an example embodiment. Data 2202 may be provided as an input to insight generator 2204. Data 2202 may include, for example, site data, such as utility bills, building characteristics, goals and targets, etc., and auxiliary data, such as emissions factors, benchmarks, regulations, etc. The data may be provided by the system or platform in a standard format.

The insight generator 2204 may generate insights via a common core model. In addition to the common core model, the insight generator 2204 may utilize per-use-case plugins. The insight generator 2204 may include a core quantitative model. For example, the core quantitative model may be a model for utility consumption analysis and forecasting. Per-use-case plug-ins may be, for example, regulation compliance, progress to specific goals, anomaly detection, seasonal trends, etc.

The insights generated by the insight generator 2204 may be used as inputs to the generative AI summarizer 2206. The generative AI summarizer 2208 may generate a summary of the key insights determined by the insight generator 2206. The key insights may be generated or displayed using natural or readable language. The generative AI summarizer 2208 may aggregate information across a portfolio (e.g., a company's equipment, building, etc. portfolio). The generative AI summarizer 2208 may further determine and highlight important or relevant insights for the user. The insights may be compared to past insights to determine how the building or equipment is performing or to see how an improvement has impacted performance. The generative AI summarizer 2208 may include in the summary a link to detailed UIs.

The UI 2208 may display information to a user on, for example, a user or mobile device. The UI 2208 may be any of the UIs 600-1600. Information displayed on the UI 2208 may be one or more of the insights generated by the insight generator 2204 and/or the summaries generated by the generative AI summarizer 2208. The UI 2208 may display actional insights (e.g., actions to implement to achieve the recommendations) with data-driven justification (e.g., visual data supporting the actions and recommendations).

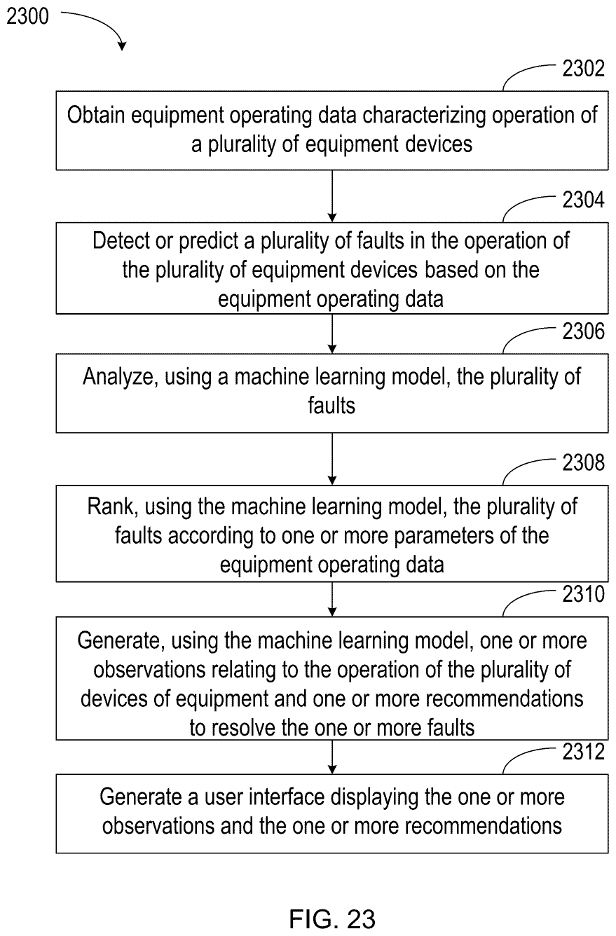

Referring now to FIG. 23, a method 2300 is shown for identifying and ranking faults, according to an example embodiment.

At process 2302, equipment operating data characterizing operation of a plurality of equipment devices is obtained. In some embodiments, the plurality of equipment devices are distributed across a plurality of equipment sites including a building site and the plurality of equipment devices include HVAC equipment located at the building site.

At process 2304, a plurality of faults in the operation of the plurality of equipment devices based on the equipment operating data are detected or predicted.

At process 2306, the plurality of faults are analyzed. The plurality of faults may be analyzed by a machine learning model (e.g., one or more LLMs as described herein).

At process 2308, the plurality of faults are ranked. The plurality of faults may be ranked according to one or more parameters of the equipment operating data.

Ranking the plurality of faults may include: analyzing, by the machine learning model, the equipment operating data for each of the plurality of devices to identify one or more types of data of the equipment operating data. For example, the data used to identify the faults (e.g., by the FDD layer 416) may be analyzed. The data may include, for example, operating data, consumption or use data, emissions data, cost data, etc. Ranking may further include weighting, by the machine learning model, each of the one or more types of data based on a relevance of each of the one or more types of data to the one or more parameters of the equipment operating data. The one or more parameters of the equipment operating data may include at least one of: an emissions impact of the device of equipment or a cost of the device of equipment. For example, the faults may be ranked according to an emissions impact of each fault (e.g., a parameter). The one or more types of data may include cost data, electricity consumption, electricity savings, water consumption, total energy consumption, total energy savings, etc. Each of the types of data analyzed by the machine learning model may be weighted according to an importance of the data to the parameter (e.g., the emissions impact).

The machine learning model may then generate a score indicative of the weighted one or more types of data. Ranking the faults further include prioritizing, by the machine learning model, the plurality of faults based on the generated scores.

At process 2310, one or more observations relating to the operation of the plurality of equipment devices and one or more recommendations to resolve the one or more faults are generated. The observations and recommendations may be generated by the machine learning model. In some embodiments, the one or more recommendations include one or more service events to service the plurality of equipment devices to resolve the one or more faults. Accordingly, in some embodiments, the method 2300 further includes initiating an automated action to perform the one or more service events. For example, a work order may be generated, a service request may be generated, etc., such that a service technician services the equipment to resolve the fault.

At process 2312, a user interface displaying the one or more observations and the one or more recommendations is generated. The generated user interface may be any of the user interfaces described herein.

In some embodiments, the method 2300 further includes identifying a root cause of a first fault of the plurality of faults associated with a first device of the plurality of equipment devices. The method 2300 may further include determining that the root cause of the first fault is a fault of a second device of the plurality of equipment devices and generating, on a user interface displaying the one or more observations and the one or more recommendations of the first fault, an element indicating that the second device of the plurality of equipment devices is the root cause of the first fault.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A system comprising:
a plurality of equipment devices; and
a controller comprising one or more memories storing instructions thereon that, when executed by one or more processors, cause the one or more processors to:
obtain equipment operating data characterizing operation of a plurality of equipment devices;
detect or predict a plurality of faults in the operation of the plurality of equipment devices based on the equipment operating data;
analyze, using a machine learning model, the plurality of faults;
rank, using the machine learning model, the plurality of faults according to one or more parameters of the equipment operating data;
generate, using the machine learning model, one or more observations relating to the operation of the plurality of equipment devices and one or more recommendations to resolve the one or more faults; and
generate, by the one or more processors, a user interface displaying the one or more observations and the one or more recommendations.

2. The system of claim 1, wherein the one or more recommendations comprise one or more service events to service the plurality of equipment devices to resolve the one or more faults.

3. The system of claim 2, wherein the instructions further cause the one or more processors to:
Initiate an automated action to perform the one or more service events.

4. The system of claim 1, wherein the plurality of equipment devices are distributed across a plurality of equipment sites comprising a building site and the plurality of equipment devices comprise HVAC equipment located at the building site.

5. The system of claim 1, wherein ranking the plurality of faults comprises:
analyzing, by the machine learning model, the equipment operating data for each of the plurality of devices to identify one or more types of data of the equipment operating data;
weighting, by the machine learning model, each of the one or more types of data based on a relevance of each of the one or more types of data to the one or more parameters of the equipment operating data;
generating, by the machine learning model, a score indicative of the weighted one or more types of data; and
prioritizing, by the machine learning model, the plurality of faults based on the generated scores.

6. The system of claim 5, wherein the one or more parameters of the equipment operating data comprise at least one of: an emissions impact of the device of equipment or a cost of the device of equipment.

7. The system of claim 1, wherein the instructions further cause the one or more processors to:
identify a root cause of a first fault of the plurality of faults associated with a first device of the plurality of equipment devices;
determine that the root cause of the first fault is a fault of a second device of the plurality of equipment devices; and
generate, on a user interface displaying the one or more observations and the one or more recommendations of the first fault, an element indicating that the second device of the plurality of equipment devices is the root cause of the first fault.

8. A method comprising:
obtaining, by one or more processors, equipment operating data characterizing operation of a plurality of equipment devices;
detecting or predicting, by the one or more processors, a plurality of faults in the operation of the plurality of equipment devices based on the equipment operating data;
analyzing, by the one or more processors, using a machine learning model, the plurality of faults;
ranking, by the one or more processors, using the machine learning model, the plurality of faults according to one or more parameters of the equipment operating data;
generating, by the one or more processors, using the machine learning model, one or more observations relating to the operation of the plurality of equipment devices and one or more recommendations to resolve the one or more faults; and
generating, by the one or more processors, a user interface displaying the one or more observations and the one or more recommendations.

9. The method of claim 8, wherein the one or more recommendations comprise one or more service events to service the plurality of equipment devices to resolve the one or more faults.

10. The method of claim 9, further comprising:
initiating, by the one or more processors, an automated action to perform the one or more service events.

11. The method of claim 8, wherein the plurality of equipment devices are distributed across a plurality of equipment sites comprising a building site and the plurality of equipment devices comprise HVAC equipment located at the building site.

12. The method of claim 8, wherein ranking the plurality of faults comprises:
analyzing, by the one or more processors, using the machine learning model, the equipment operating data for each of the plurality of devices to identify one or more types of data of the equipment operating data;
weighting, by the one or more processors, using the machine learning model, each of the one or more types of data based on a relevance of each of the one or more types of data to the one or more parameters of the equipment operating data;
generating, by the one or more processors, using the machine learning model, a score indicative of the weighted one or more types of data; and
prioritizing, by the one or more processors, using the machine learning model, the plurality of faults based on the generated scores.

13. The method of claim 12, wherein the one or more parameters of the equipment operating data comprise at least one of: an emissions impact of the device of equipment or a cost of the device of equipment.

14. The method of claim 8, further comprising:
identifying, by the one or more processors, a root cause of a first fault of the plurality of faults associated with a first device of the plurality of equipment devices;
determining, by the one or more processors, that the root cause of the first fault is a fault of a second device of the plurality of equipment devices; and
generating, by the one or more processors, on a user interface displaying the one or more observations and the one or more recommendations of the first fault, an element indicating that the second device of the plurality of equipment devices is the root cause of the first fault.

15. One or more non-transitory computer-readable media comprising one or more memories storing instructions thereon that, when executed by one or more processors, cause the one or more processors to:
obtain equipment operating data characterizing operation of a plurality of equipment devices;
detect or predict a plurality of faults in the operation of the plurality of equipment devices based on the equipment operating data;
analyze, using a machine learning model, the plurality of faults;
rank, using the machine learning model, the plurality of faults according to one or more parameters of the equipment operating data;
generate, using the machine learning model, one or more observations relating to the operation of the plurality of equipment devices and one or more recommendations to resolve the one or more faults; and
generate a user interface displaying the one or more observations and the one or more recommendations.

16. The one or more non-transitory computer-readable media of claim 15, wherein the one or more recommendations comprise one or more service events to service the plurality of equipment devices to resolve the one or more faults.

17. The one or more non-transitory computer-readable media of claim 16, wherein the instructions further cause the one or more processors to:
initiate an automated action to perform the one or more service events.

18. The one or more non-transitory computer-readable media of claim 15, wherein ranking the plurality of faults comprises:
analyzing, by the machine learning model, the equipment operating data for each of the plurality of devices to identify one or more types of data of the equipment operating data;
weighting, by the machine learning model, each of the one or more types of data based on a relevance of each of the one or more types of data to the one or more parameters of the equipment operating data;
generating, by the machine learning model, a score indicative of the weighted one or more types of data; and
prioritizing, by the machine learning model, the plurality of faults based on the generated scores.

19. The one or more non-transitory computer-readable media of claim 18, wherein the one or more parameters of the equipment operating data comprise at least one of: an emissions impact of the device of equipment or a cost of the device of equipment.

20. The one or more non-transitory computer-readable media of claim 15, wherein the instructions further cause the one or more processors to:
identify a root cause of a first fault of the plurality of faults associated with a first device of the plurality of equipment devices;
determine that the root cause of the first fault is a fault of a second device of the plurality of equipment devices; and
generate, on a user interface displaying the one or more observations and the one or more recommendations of the first fault, an element indicating that the second device of the plurality of equipment devices is the root cause of the first fault.
